(19) United States
(12) Patent Application Publication
(10) Pub. No.: US 2016/0080588 A1
(43) Pub. Date: Mar. 17, 2016

(54) INFORMATION PROCESSING SYSTEM, INFORMATION PROCESSING METHOD, AND RECORDING MEDIUM STORING AN INFORMATION PROCESSING PROGRAM

(71) Applicants: Tohru SASAKI, Kanagawa (JP); Tomohiro Kuroyanagi, Kanagawa (JP); Atsushi Okazato, Kanagawa (JP); Makoto Sasaki, Kanagawa (JP); Junki Aoki, Kanagawa (JP); Takuya Mori, Tokyo (JP); Hirohisa Saitoh, Tokyo (JP); Mie Watanabe, Tokyo (JP); Tatsuo Nishimura, Tokyo (JP); Yukinori Ishii, Kanagawa (JP); Hiroyuki Sakuyama, Tokyo (JP); Fumihiro Umetsu, Kanagawa (JP); Itaru Kodaira, Kanagawa (JP); Naoki Shimizu, Kanagawa (JP); Akira Yokoyama, Kanagawa (JP); Hiroaki Ikkanzaka, Tokyo (JP); Tadashi Sato, Kanagawa (JP); Takashi Toriumi, Kanagawa (JP); Fumiyoshi Kittaka, Kanagawa (JP)

(72) Inventors: Tohru SASAKI, Kanagawa (JP); Tomohiro Kuroyanagi, Kanagawa (JP); Atsushi Okazato, Kanagawa (JP); Makoto Sasaki, Kanagawa (JP); Junki Aoki, Kanagawa (JP); Takuya Mori, Tokyo (JP); Hirohisa Saitoh, Tokyo (JP); Mie Watanabe, Tokyo (JP); Tatsuo Nishimura, Tokyo (JP); Yukinori Ishii, Kanagawa (JP); Hiroyuki Sakuyama, Tokyo (JP); Fumihiro Umetsu, Kanagawa (JP); Itaru Kodaira, Kanagawa (JP); Naoki Shimizu, Kanagawa (JP); Akira Yokoyama, Kanagawa (JP); Hiroaki Ikkanzaka, Tokyo (JP); Tadashi Sato, Kanagawa (JP); Takashi Toriumi, Kanagawa (JP); Fumiyoshi Kittaka, Kanagawa (JP)

(21) Appl. No.: 14/851,177

(22) Filed: Sep. 11, 2015

(30) Foreign Application Priority Data
Sep. 17, 2014 (JP) 2014-189016

(51) Int. Cl. H04N 1/00; G06F 3/12

(52) U.S. Cl. CPC H04N 1/00244; G06F 3/1222; G06F 3/1238; G06F 3/1273; G06F 3/1296; H04N 1/00384; H04N 1/00392; H04N 2201/0094

(57) ABSTRACT

An information processing system includes an execution request unit that requests one or more multiple preregistered apparatuses to execute an operation, an authority information acquisition unit that acquires authority information that indicates user authority on the preregistered apparatus from at least one of the preregistered apparatuses, an authority management information generator that generates authority management information that indicates the user authority applied to the preregistered apparatuses based on the authority information that the authority information acquisition unit acquires, and a controller that controls whether or not to allow the execution request unit to request to execute the operation based on the authority management information.

### CROSS-REFERENCE TO RELATED APPLICATION

This patent application is based on and claims priority pursuant to 35 U.S.C. §119(a) to Japanese Patent Application No. 2014-189016, filed on Sep. 17, 2014 in the Japan Patent Office, the entire disclosure of which is hereby incorporated by reference herein.

### BACKGROUND

1. Technical Field

The present invention relates to an information processing system, an information processing method, and a non-transitory recording medium storing an information processing program.

2. Background Art

In a network environment in which multiple apparatuses are connected, for a function that an apparatus cannot perform alone, a technology that enables multiple apparatuses with different functions to cooperate with each other, to search for an apparatus capable of the function, and once found, to cause the capable apparatus to execute the function is known.

In addition, if multiple apparatuses cooperate with each other and user authorities (e.g., account and function limitation) are configured for each apparatus, a technology that provides functions within the limits of the user authority is known.

For example, if a source apparatus searches for a function through another apparatus, the source apparatus requests the other apparatus to search for the function adding function limitation information configured for each user. After receiving the request for searching for the function, the other apparatus responds to the source apparatus with a search result excluding the limited functions reflecting the added function limitation information.

As a result, if multiple apparatuses cooperate with each other to perform a process, it is possible to limit usage of a function included in another apparatus reflecting function limitation information for each user.

### SUMMARY

An example embodiment of the present invention provides a novel information processing system that includes an execution request unit that requests one or more multiple preregistered apparatuses to execute an operation, an authority information acquisition unit that acquires authority information that indicates user authority on the preregistered apparatus from at least one of the preregistered apparatuses, an authority management information generator that generates authority management information that indicates the user authority applied to the preregistered apparatuses based on the authority information that the authority information acquisition unit acquires, and a controller that controls whether or not to allow the execution request unit to request to execute the operation based on the authority management information.

Further example embodiments of the present invention provide an information processing method and a non-transitory recording medium storing an information processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating a cooperative system and hardware configurations of a cooperative server and image forming apparatus preregistered in the cooperative system as an embodiment of the present invention.

FIG. 2 is a diagram illustrating functional blocks for performing a cooperative operation by the cooperative server and the image processing apparatus connected to the cooperative system in FIG. 1 as an embodiment of the present invention.

FIG. 3 is a sequence diagram illustrating a process of registering an apparatus to cooperate with in the cooperative server as an embodiment of the present invention.

FIG. 4 is a sequence diagram illustrating a process of logging in the image forming apparatus registered in the cooperative server as an embodiment of the present invention.

FIG. 5 is a sequence diagram illustrating a process in which the image forming apparatus performs with the cooperative server in acquiring cooperative function available in the cooperative system after the login in FIG. 4 as an embodiment of the present invention.

FIG. 6 is a sequence diagram illustrating a process in which the cooperative server performs to acquire the cooperative function with the other image forming apparatus as an embodiment of the present invention.

FIG. 7 is a sequence diagram illustrating the process continued from FIG. 6.

FIG. 8 is a sequence diagram illustrating a process in which the other image forming apparatus performs when the cooperative server logs in the other image forming apparatus during the process in FIG. 6.

FIG. 9 is a sequence diagram illustrating a process in which the other image forming apparatus performs when the cooperative server requests the other image forming apparatus to acquire user authority during the process in FIG. 6.

FIG. 10 is a diagram illustrating user authority information in the multiple image forming apparatus preregistered in the cooperative server as an embodiment of the present invention.

FIG. 11 is a flowchart illustrating a process of generating authority management information as an embodiment of the present invention.

FIG. 12 is a diagram illustrating the authority management information generated by the process in FIG. 11.

FIG. 13 is a flowchart illustrating another process of generating authority management information as an embodiment of the present invention.

FIG. 14 is a diagram illustrating the authority management information generated by the process in FIG. 13.

FIGS. 15A and 15B are sequence diagrams illustrating a process of executing a job of the cooperative operation and registering a log of the executed job.

FIGS. 16A and 16B are sequence diagrams illustrating the process continued from FIGS. 15A and 15B.

FIG. 17 is a sequence diagram illustrating the process continued from FIGS. 15A and 15B.

FIGS. 18A and 18B are sequence diagrams illustrating a process of referring to a log of a job of the cooperative operation and collecting the log.

FIG. 19 is a sequence diagram illustrating the process continued from FIGS. 18A and 18B.

FIG. 20 is a sequence diagram illustrating the process continued from FIGS. 18A and 18B.

FIG. 21 is a diagram illustrating a process of collecting a log in the cooperative operation as an embodiment of the present invention.

FIG. 22 is a diagram illustrating another process of collecting a log in the cooperative operation as an embodiment of the present invention.

FIG. 23 is a diagram illustrating yet another process of collecting a log in the cooperative operation as an embodiment of the present invention.

FIG. 24 is a diagram illustrating a process of executing a job using a history of the collected log and using the log used from the history as the log of the job.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In some cases, by combining apparatuses on which user authorities have been configured already, it is possible to construct a system that can execute a in which multiple apparatuses cooperate with each other. In this case, in case of operating the system in accordance with user authorities configured in each apparatus, it could be difficult to determine to allow each user to perform an operation in the system since authority configuration on one apparatus conflicts with authority configuration on another apparatus, or an authorized user on one apparatus is different from an authorized user on another apparatus.

In addition, in case of adding a new apparatus to the system, it is desired to configure user authority on the new apparatus individually. Otherwise, it is desired to allow users to perform all operations or reject all operations for users, thus complicating the configuration.

On the other hand, if system-dependent authority is configured for users regardless of authorities on each apparatus, it is desired to consider which operation can be allowed to each user from the beginning, thus complicating the configuration.

In the following embodiment, a cooperative system including multiple apparatuses configuring user authority individually that can reflect existing authority configuration in each apparatus and control the cooperative operation appropriately is described.

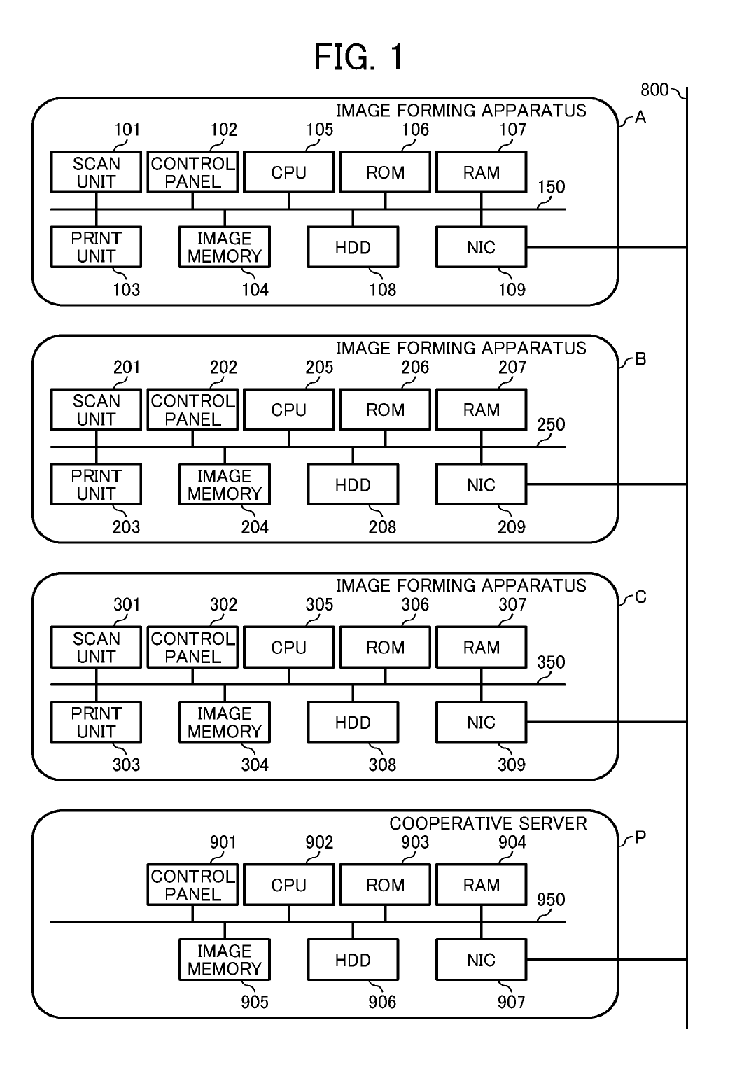

FIG. 1 is a diagram illustrating a cooperative system and hardware configurations of a cooperative server and image forming apparatus preregistered in the cooperative system in this embodiment.

The configuration of the cooperative system and the hardware of the cooperative server and the multiple image forming apparatuses preregistered in the cooperative system is described below with reference to FIG. 1.

In FIG. 1, the cooperative server P and image forming apparatuses A, B, and C including an image forming unit to form an image on a recording medium are connected to a network 800 to construct the cooperative system.

For example, a Local Area Network (LAN) can be used for the network 800. However, the network 800 is not limited thereto, and networks with any standard regardless of wired or wireless can be used so long as each apparatus can cooperate with each other. It is also possible to use the Internet as the network 800.

In addition, the apparatuses registered in the cooperative server can be single-function apparatuses such as a scanner, copier, facsimile, and printer or a multifunction peripheral (MFP). The number of those apparatuses is not limited, too.

Furthermore, the cooperative server can work as a server only, or it is possible that the cooperative server includes functions of apparatuses such as the MFP and works as the cooperative apparatus itself.

Next, the hardware of the image forming apparatus A in FIG. 1 is described below.

Since the hardware of the image forming apparatuses B and C includes the same functions as the image forming apparatus A, those descriptions are omitted. The hardware configuration of the cooperative server P is the same as the image forming apparatus A except a scan unit 101 and a print unit 103.

The image forming apparatus A includes the scan unit 101, a control panel 102, the print unit 103, an image memory 104, a CPU 105, a ROM 106, a RAM 107, a HDD 108, and a Network Interface Card (NIC) 109, and those units are connected via a system bus 150.

In the above configuration, the scan unit 101 scans an image on a document, etc., and acquires its image data.

The control panel 102 is a user interface that includes operation units to accept user operation such as keys, buttons, and touch sensors and display units such as a display to present information to users.

The print unit 103 includes a function to form an image on paper based on the image data processed in the image forming apparatus.

The image memory 104 is a storage unit to store the image data.

The CPU 105 controls the entire image forming apparatus A by executing a program stored in the ROM 106 or the HDD 108 using the RAM 107 as a work area, and various functions (described later) can be implemented.

The HDD 106 is a non-volatile storage medium that stores programs and data.

The RAM 107 is a volatile storage device to read and write programs and data.

The HDD 108 is a storage unit to store the image data etc.

The NIC 109 is a communication unit to connect the apparatus to the network.

The system bus 150 is a transmission line to connect the units described above with each other and exchange data in the computer.

The hardware of the image forming apparatus A is described above. However, the image forming apparatus is known and can include hardware configuration other than the units described above.

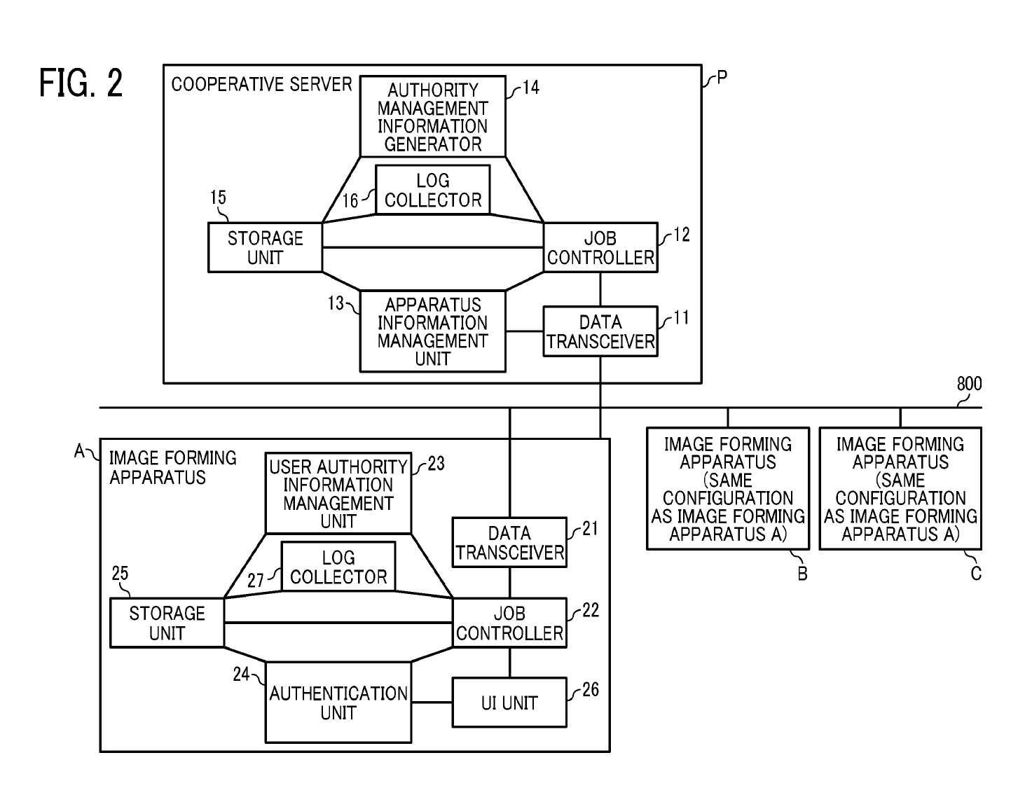

FIG. 2 is a diagram illustrating functional blocks for performing a cooperative operation by the cooperative server connected to the cooperative system and the multiple image processing apparatuses preregistered in the cooperative system in this embodiment. A function regarding a process performed by the cooperative server and the image forming apparatus connected to the cooperative system using the cooperative system is described below with reference to FIG. 2.

The functional units in FIG. 2 are implemented by executing predetermined programs by the CPU in the cooperative server and each apparatus connected to the cooperative system in FIG. 1 and controlling predetermined hardware of the cooperative server and the apparatus.

First, functions that the cooperative server P includes is described below. The cooperative server P includes a data transceiver 11, a job controller 12, an apparatus information management unit 13, an authority management information generator 14, a storage unit 15, and a log collector 16.

Here, the data transceiver 11 receives various requests from the image forming apparatuses A, B, and C preregistered in the cooperative system and transfers response to those requests, distributing the received requests to a module that processes the request.

In executing a job cooperating with the image forming apparatus preregistered in the cooperative system, the job controller 12 requests each image forming apparatus to execute the job.

The apparatus information management unit 13 manages the image forming apparatuses preregistered to the cooperative server and information on functions that the apparatus includes etc.

The authority management information generator 14 acquires authority information indicating user authority in an image forming apparatus from some of the image forming apparatuses preregistered in the cooperative server at least and generate authority management information applied to the preregistered apparatus based on the acquired authority information.

Here, the user authority information indicates whether or not each function included in the image forming apparatus is available.

The storage unit 15 stores information desired to perform the cooperative operation on the image forming apparatus preregistered in the cooperative server such as user account and information desired to collect a log of a job executed using the cooperative system etc. While the function is implemented by the HDD 906 in the cooperative server P, it is possible to use an external storage device.

It should be noted that the user account means various information related to a user, such as authentication information, e.g., login name and password, etc., and authority management information associated with user, etc.

The log collector 16 collects a log of a job executed using the cooperative system from each image forming apparatus preregistered to the cooperative server.

The functions that the cooperative server P includes to implement the cooperative operation in this embodiment are described above.

Next, functions that the image forming apparatus A includes are described below. The image forming apparatus A includes a data transceiver 21, a job controller 22, a user authority information management unit 23, an authentication unit 24, a storage unit 25, a user interface (UI) unit 26, and a log collector 27.

The data transceiver 21 receives various requests transferred by the data transceiver 11 in the cooperative server P in the cooperative system and transfers response to those requests.

In executing the job cooperating with the image forming apparatus preregistered to the cooperative server, after receiving the request for executing the job from the cooperative server P, the job controller 22 executes the job or requests the cooperative server P to execute the job.

The user authority information management unit 23 manages user accounts. Here, the user account means various information related to user such as authentication information e.g., login name and password etc. and authority management information associated with user etc.

The authentication unit 24 authenticates user operation on the image forming apparatus A using the user authentication information.

The storage unit 25 stores information desired to perform the cooperative operation on the image forming apparatus preregistered to the cooperative server such as user account and a log of a job executed by the image forming apparatus actually. While the function is implemented by the HDD 108 in the image forming apparatus A, it is possible to use an external storage device.

The UI unit 26 provides UIs that accepts user operation using various operation units and the display unit that the control panel 102 includes and presents information.

The log collector 27 collects a log of a job executed by the image forming apparatus A.

The functions that the image forming apparatus A includes to implement the cooperative operation in this embodiment are described above.

The functions described above are desired to implement the cooperative operation by the cooperative system, and the image forming apparatus A can include other functions. The functions for implementing the cooperative operation included in the image forming apparatuses B and C are the same as the image forming apparatus A, and those descriptions are omitted. In the descriptions below, while same symbols are used for the same units, it is possible to distinguish which apparatus the unit belongs to in the description.

One of characteristics in the cooperative system including the cooperative server P and the image forming apparatuses A, B, and C described above is that it is possible to manage authorities in the cooperative operation in accordance with user authorities configured in each apparatus even if different user authorities are configured for each apparatus. Processes that each apparatus executes to implement the above function is described below.

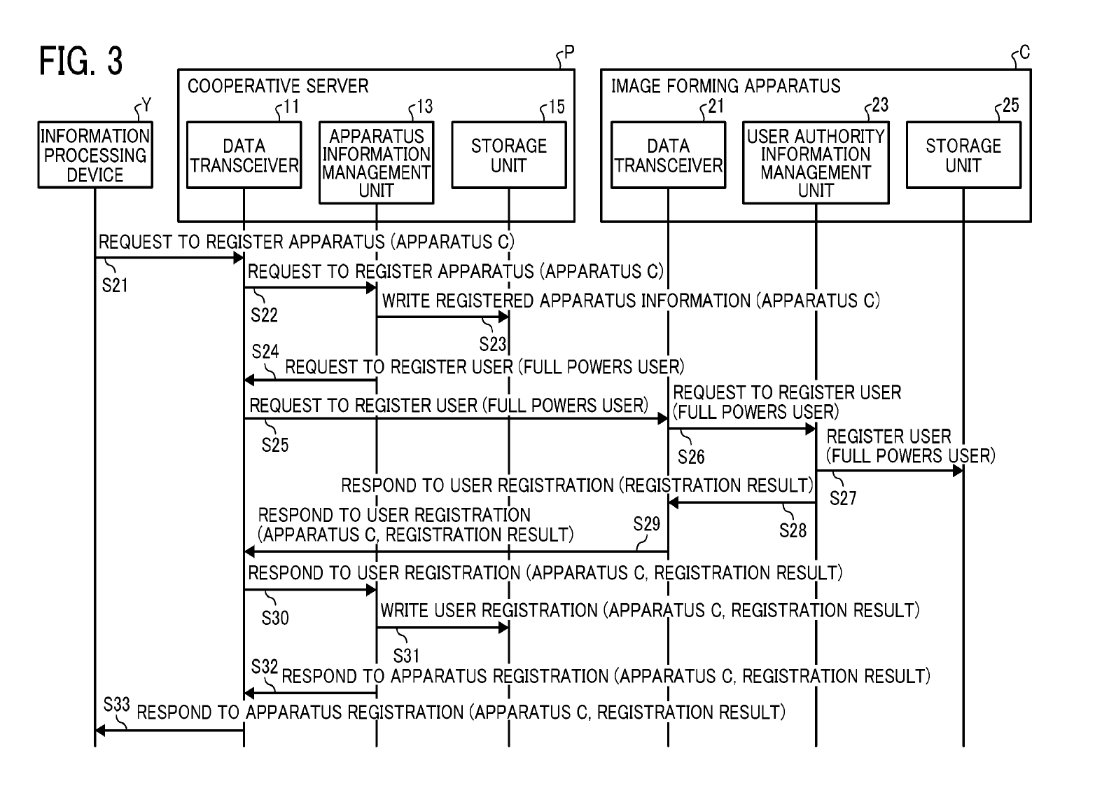

First, an operation of registering an apparatus to cooperate in the cooperative system is described below with reference to FIG. 3.

In FIG. 3, a process in which requests the cooperative server P using the information processing device Y by user operation to register the image forming apparatus C in the cooperative system is shown.

In this case, first, the information processing device Y transfers an apparatus registration request to register the image forming apparatus C in the cooperative server P to the cooperative server P in S21. In this case, the information processing device Y also transfers information for specifying the image forming apparatus C to be registered along with the request. After receiving the request, the data transceiver 11 in the cooperative server P passes the apparatus registration request and the information on the image forming apparatus C to the apparatus information management unit 13 in S22.

In this case, the information on the image forming apparatus C includes information that can identify the image forming apparatus in the network 800 such as Internet Protocol (IP) address etc. In addition, the information on the image forming apparatus C includes authentication information such as an administrator ID and password desired when the cooperative server P accesses the image forming apparatus C to request to generate a full powers user (described later) if desired. It is also possible that the information on the image forming apparatus C include information such as an apparatus name and apparatus model to identify the image forming apparatus C by user operation.

After accepting the apparatus registration request in S22, the apparatus information management unit 13 writes the information on the image forming apparatus C in the storage unit 15 in S23.

In addition, the apparatus information management unit 13 requests the image forming apparatus C to register the full powers user authorized to execute all functions in the image forming apparatus C (and logs in the image forming apparatus C prior to that or at the same time as that if desired) in S24 to S26.

More specifically, in the first place, the apparatus information management unit 13 requests the data transceiver 11 to transfer a request to register the full powers user along with the authentication information desired to generate the full power user such as the administrator ID and password etc. to the image forming apparatus C in S24, and the data transceiver 11 transfers the user registration request to the data transceiver 21 in the image forming apparatus C in S25. Subsequently, the data transceiver 21 passes the received user registration request to the user authority information management unit 23 that processes the user registration request in the image forming apparatus C in S26.

As described above, the data transceivers 11 and 21 in both apparatuses involve in transferring/receiving requests and responses between the apparatuses, and the data transceivers 11 and 21 only transfer/distribute the data to be transferred or received to the destination. Therefore, in the description below, a functional unit that generates a request or response transfers the request or response to an apparatus that processes the request or response.

In FIG. 3, after receiving the user registration request, the user authority information management unit 23 in the image forming apparatus C registers the full powers user in the storage unit 25 in S27 and acknowledges the cooperative server P with the registration result in S28 to S30.

The process of registering the full power user in the storage unit is a storing process, and the CPU 305 in the image forming apparatus C functions as a storing unit in that process. The cases in the image forming apparatuses A and B are the same as the case in the image forming apparatus C described above.

In the cooperative server P, the apparatus information management unit 13 receives the response of the registration result. If the response indicates that the registration succeeded, it is written in the storage unit 15 that the full powers user of the image forming apparatus C has been registered in S31. In addition, it is acknowledged the information processing device Y as the source of requesting to register the apparatus that the apparatus registration response for the image forming apparatus C has been finished in S32 and S33, and the apparatus registration request process ends.

As described above, it is possible to register the new apparatus in the cooperative system easily.

As a result, the image forming apparatus C is registered in the cooperative server P and becomes available in the cooperative system. Likewise, the image forming apparatuses A and B are registered in the cooperative server P.

After the process in FIG. 3, it is possible that the cooperative server P collects information on functions that the image forming apparatus C includes from the image forming apparatus C and writes the information in the storage unit 15.

In addition, it is possible that the information processing device Y accesses the cooperative server by user operation. Examples of the information processing device Y are a personal computer (PC) and a mobile device such as a smartphone and a tablet.

Here, apparatuses registered in the cooperative system are configured for user accounts individually, and users registered in each apparatus can log in the image forming apparatuses A, B, and C directly and operate the image forming apparatuses A, B, and C without the intermediary of the cooperative server P. A process of logging in is described below.

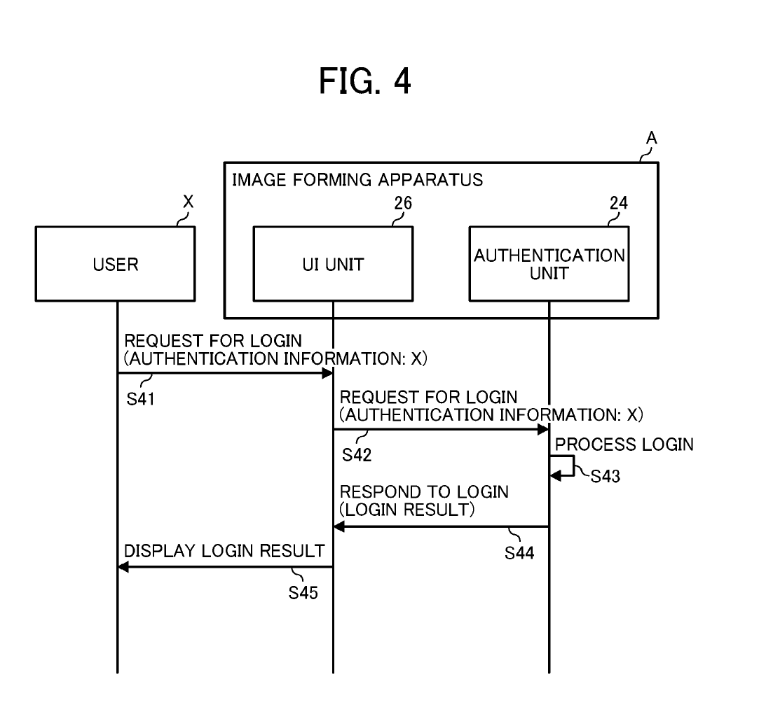

FIG. 4 is a sequence diagram illustrating a process of logging in the image forming apparatus A by user X operation. In FIG. 4, in the first place, user X's authentication information (e.g., user ID and password etc.) is input on the control panel 102 of the image forming apparatus A to request to log in by user operation. In FIG. 4, “authentication information X” indicates the user X's authentication information.

After receiving the login request in S41, the UI unit 26 in the image forming apparatus A passes the login request to the authentication unit 24 in S42. After receiving the request, the authentication unit 24 authenticates the user using the received authentication information. If the authentication succeeded, the authentication unit 24 allows the user to log in and processes the login in S43 and acknowledges the UI unit 26 with the result as the login response in S44.

The UI unit 26 displays the login result on the control panel 102 based on the login response to notify the user about the login result in S45, and the process ends. If the authentication failed, the authentication unit 24 does not process login and acknowledges the UI unit 26 with the result indicating that the login failed.

After finishing logging in normally as described above, the user X can command the image forming apparatus A to execute a job. The above job includes a cooperative operation that multiple image forming apparatuses cooperate with each other using the cooperative server P.

In the description below, it is assumed that the image forming apparatuses A, B, and C have already been registered in the cooperative server P as shown in FIG. 3 and the user X has already logged in the image forming apparatus A as shown in FIG. 4.

Next, a process in which the image forming apparatus A becomes a state that can accept a command to execute a cooperative operation by user X operation is described below.

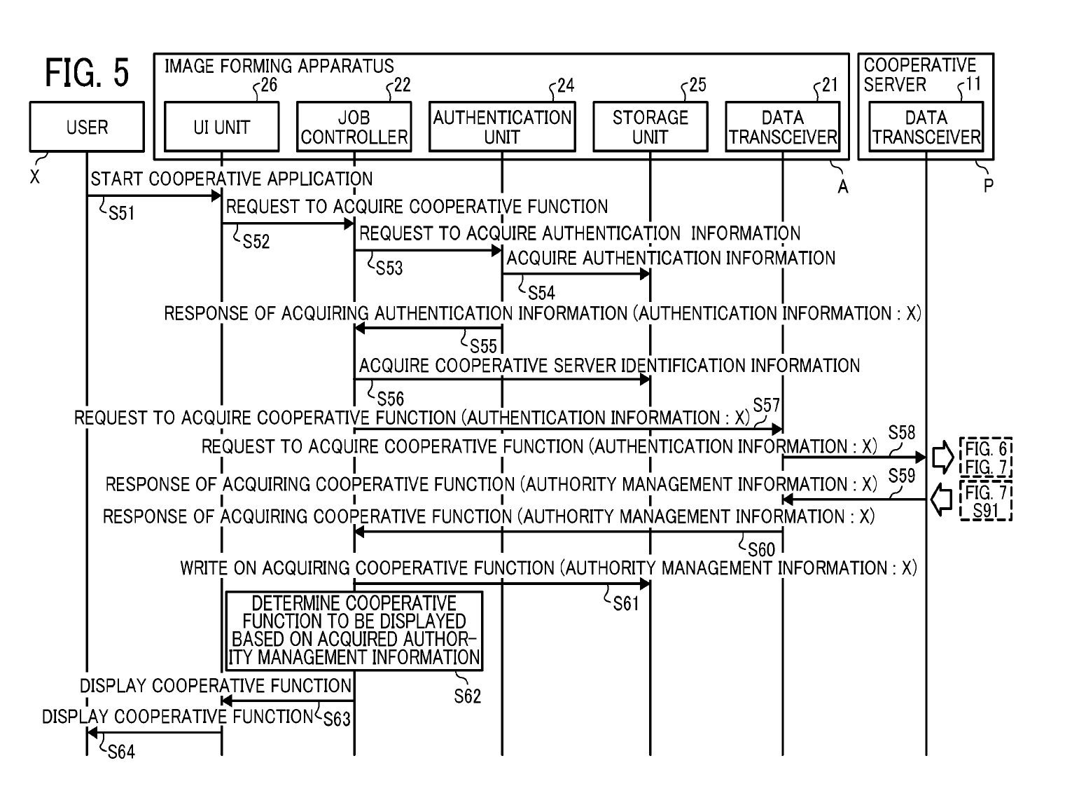

FIGS. 5 to 9 are sequence diagrams illustrating the process. While the process is a sequent operation, it is divided into multiple figures as a matter of description convenience.

In case of commanding to execute the cooperative operation via the image forming apparatus A, it is commanded to start a cooperative application for using the cooperative system on the control panel 102 of the image forming apparatus A by user operation in S51.

After receiving the command, the UT unit 26 in the image forming apparatus A requests the job controller 22 to acquire a cooperative function in S52. After receiving the request, the job controller 22 requests the authentication unit 24 to acquire the user X's authentication information desired to acquire the cooperative function in S53. After receiving the request, the authentication unit 24 acquires the user X's authentication information from the storage unit 25 in S54.

Next, the authentication unit 24 acknowledges the job controller 22 to acquire the authentication information and passes the user X's authentication information in S55. After receiving the response, the job controller 22 transfers a cooperative function acquisition request to request to acquire authority management information indicating cooperative operation executable via the cooperative server P by user X operation to the job controller 12 in the cooperative server P via the data transceivers 21 and 11. At the same time, the user X's authentication information is also passed in S57, S58, and S71.

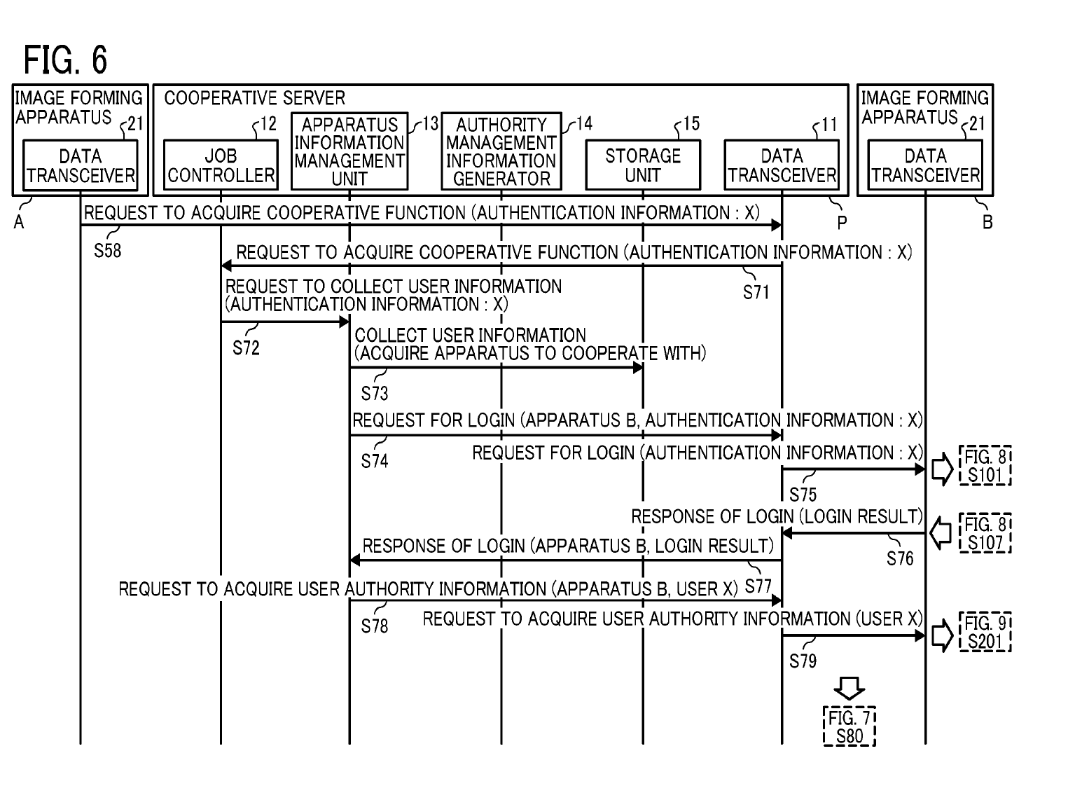

As shown in FIG. 6, after the job controller 12 in the cooperative server P receives the cooperative operation acquisition request and the user X's authentication information in S71, the user X's authentication information is passed to the apparatus information management unit 13 to request to collect user information to collect information on user authority available for user X in the cooperative system in S72. After receiving the request, the apparatus information management unit 13 acquires information on apparatuses registered in the cooperative system in S73 and passes the user X's authentication information to the job controller 22 in the image forming apparatus B as the cooperative apparatus acquired in S73 to acquire information on the user authority and request for login in S74 and S75 and S101 and S102 in FIG. 8.

A process in which the image forming apparatus B executes in processing login shown in FIG. 8 is described below.

After receiving the login request described above via the data transceiver 21 in S101 and S102, the job controller 22 in the image forming apparatus B passes the user X's authentication information included in the login request to the authentication unit 24 to request for login in S103. After receiving the request, the authentication unit 24 authenticates the user using the received authentication information. If the authentication succeeded, the authentication unit 24 allows the user to log in and processes the login in S104.

Next, the authentication unit 24 acknowledges the job controller 22 with the result as the login response in S105. If the authentication failed, the authentication unit 24 does not process login and acknowledges with the result indicating that the login failed. The job controller 22 acknowledges the apparatus information management unit 13 in the cooperative server P with the login result response via the data transceivers 21 and 11 to notify of the login result in S106, S107, S76, and S77.

The following process shown in FIG. 6 is performed when the login succeeds. If the login fails, it is possible to notify the job controller 22 in the image forming apparatus A that the login failed to display that the login failed.

If the login in the image forming apparatus B succeeds, the apparatus information management unit 13 transfers a user authority information acquisition request to acquire the user X's authority information to the job controller 22 in the image forming apparatus B via the data transceivers 11 and 21 in S78 and S79 and S201 and S202 in FIG. 9.

As shown in FIG. 9, after receiving the user authority information acquisition request in S202, the job controller 22 in the image forming apparatus B requests the user authority information management unit 23 to acquire the user X's authority information in S203. In response to the request, the user authority information management unit 23 acquires the user X's authority information on functions in the image forming apparatus B from the storage unit 25 in S204. The user authority information management unit 23 passes the acquired user X's authority information to the job controller 22 and replies that it is finished to acquire the user authority information in S205.

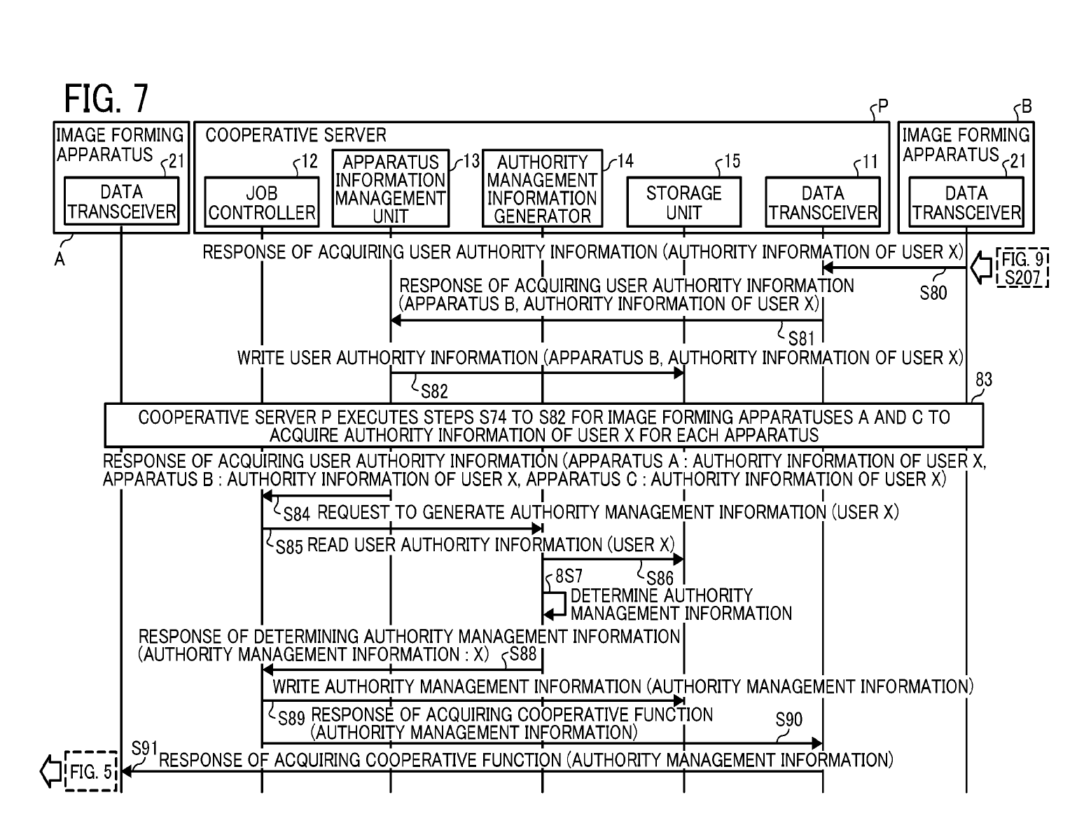

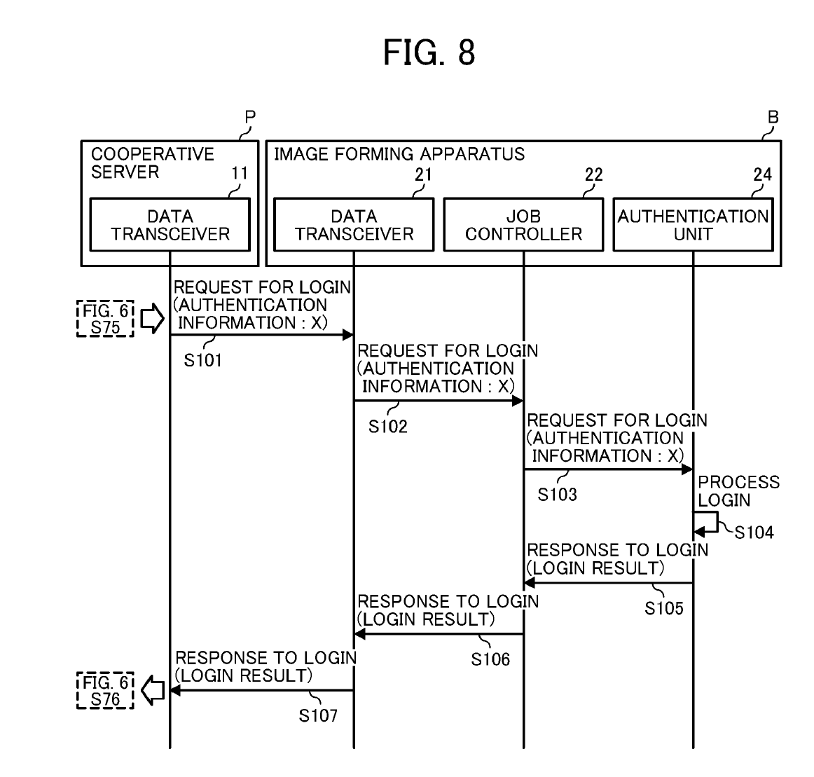

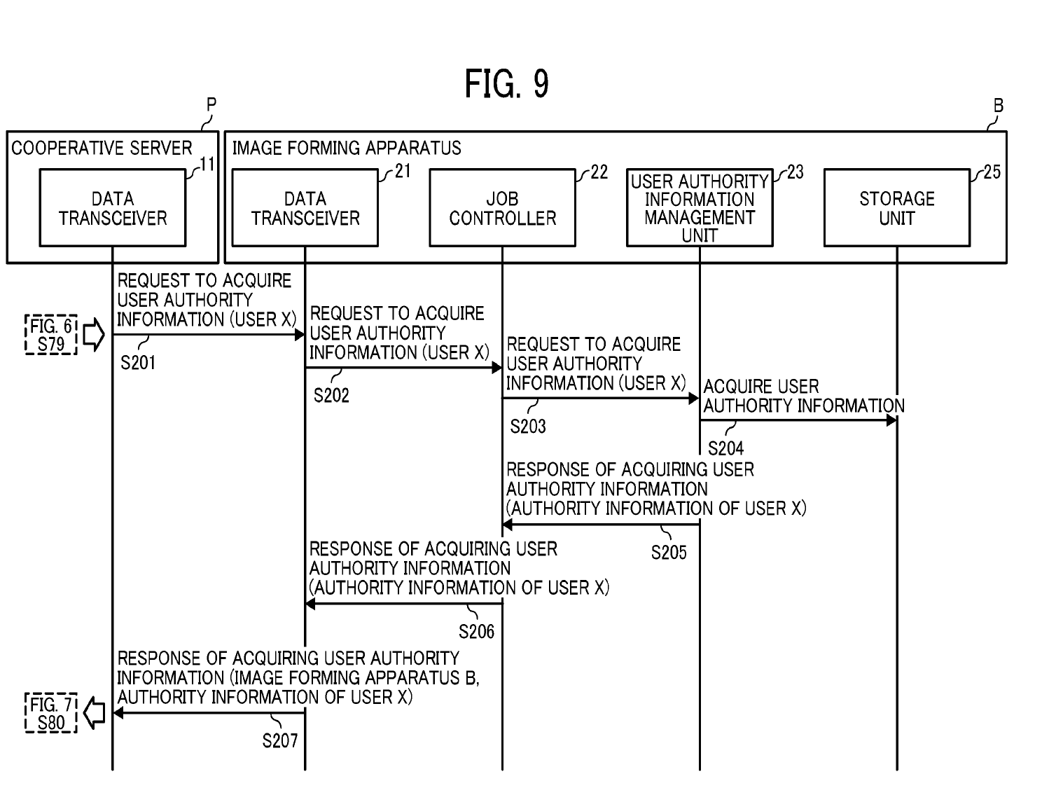

In response to the reply in S205, the job controller 22 passes the acquired user X's authority information regarding the image forming apparatus B to the apparatus information management unit 13 in the cooperative server P via the data transceivers 22 and 11 to reply that it is finished to acquire the user authority information in S206 and S207 and S80 and S81 in FIG. 7.

As shown in FIG. 7, after receiving the response in S81, the apparatus information management unit 13 writes the acquired user X's authority information in the storage unit 15 in S82.

While the process is not shown in figures, the apparatus information management unit 13 in the cooperative server P also performs steps S74 59 S82 for the image forming apparatuses A and C registered as the other cooperative apparatuses in FIG. 3 to acquire the user X's authority information for each apparatus and write it in the storage unit in S83.

Next, the apparatus information management unit 13 passes the user X's authority information on the image forming apparatuses A, B, and C to reply that the user authority information is acquired in S84.

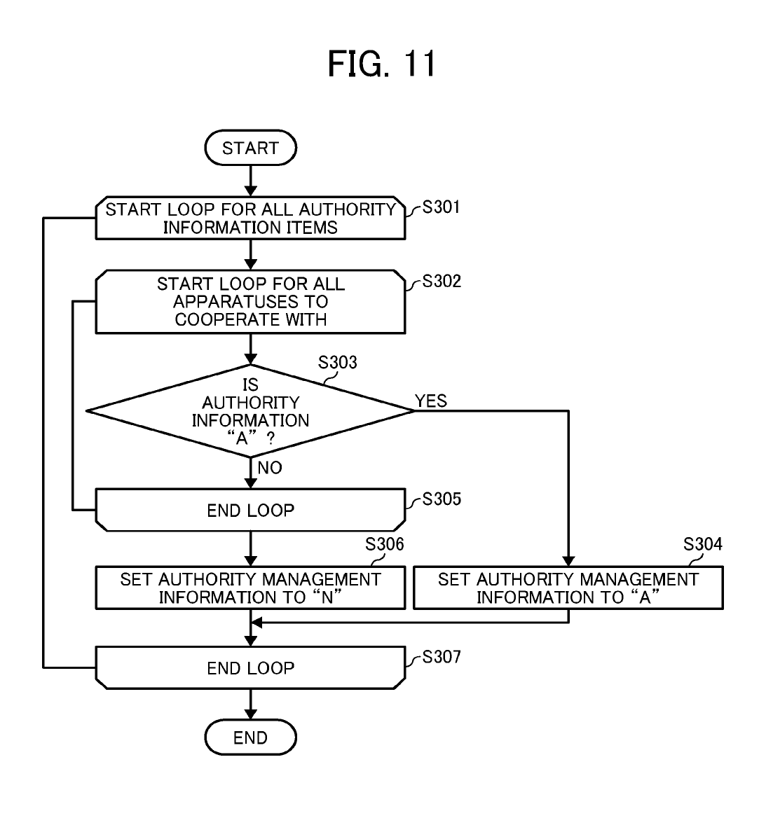

The job controller 12 requests the authority management information generator 14 to generate the user X's authority management information in S85. After receiving the request, in S86, the authority management information generator 14 reads the user X's authority information written in the storage unit 15 in S82. Subsequently, a determination process regarding the user X's authority management information is performed to generate the authority management information in S87. The determination process for generating the authority management information is described later in detail with reference to the flowchart in FIG. 11.

In S78 to S84, the cooperative server P acquires the authority information, and the CPU 902 in the cooperative server P functions as an authority information acquisition unit.

In addition, in steps S85 to S87, the cooperative server P generates the authority management information, and the CPU 902 in the cooperative server P functions as an authority management information generator.

After finishing the determination of the authority management information, the authority management information generator 14 passes the authority management information generated by the determination to the job controller 12 in S88. The job controller 12 writes the authority management information in the storage unit 15 in S89 and transfers a cooperative function acquisition response including the authority management information to the job controller 22 in the image forming apparatus A via the data transceivers 11 and 21 in S90 and S91 and S59 and S60 in FIG. 5.

As shown in FIG. 5, after receiving the cooperative function acquisition response in S60, the job controller 22 in the image forming apparatus A writes the user X's authority management information included in the cooperative function acquisition response in the storage unit 25 in S61. Subsequently, based on the acquired authority management information, the cooperative function to be displayed when the cooperative application starts up is determined in S62, and it is requested for the UI unit 26 to display the cooperative function in S63. In accordance with the request, the cooperative unit displays the cooperative function in S64.

Here, the displayed cooperative function indicates a function available for an operation executable by the user X in the cooperative system based on the user X's authority management information. A command to execute a cooperative function by user X operation is accepted within the range of the displayed functions.

The process in which the image forming apparatus A becomes a state that can accept a command to execute a cooperative operation by user X operation is described above.

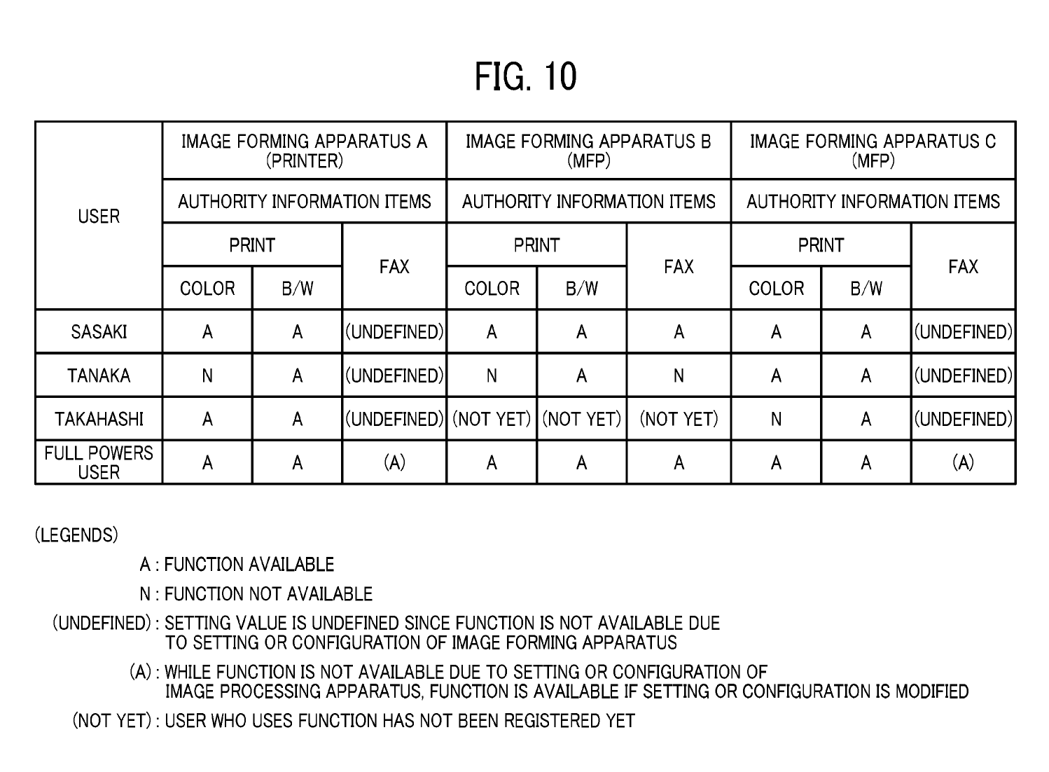

Next, a process in which the authority management information generator 14 determines the authority management information (in S87 in FIG. 7) is described below with reference to FIGS. 10 and 11.

First, content of the user X's authority information is described below with reference to FIG. 10.

FIG. 10 is a diagram illustrating user authority information on the image forming apparatuses A, B, and C acquired by the job controller 12 in S84 in FIG. 7. In FIGS. 6 and 7, the authority information for one user is acquired and written in the storage unit 15, and the authority information is kept until new information is acquired for the same user. As a result, the storage unit 15 stores authority information for all users who tries to use the cooperative system.

In FIG. 10, the authority information for three users, “Sasaki”, “Tanaka”, and “Takahashi” is stored. In FIG. 10, “full powers user” is generated when the apparatus is registered to use the cooperative system and stored in each apparatus preliminarily, and it is also illustrated in FIG. 10 for reference.

It is assumed that three apparatuses, the image forming apparatuses A (printer), B (MFP), and C (MFP) are registered in the cooperative system and the authority information items are “print/color”, “print/B/W”, and “fax” for each apparatus. While some apparatuses do not include the function in the authority information items and no authority information exists in that case, the above description is assumed to unify the data format. It should be noted that the number of apparatuses, functions, and items are not limited to the case described above.

In FIG. 10, while Sasaki can use “print/color” and “print/B/W” for the image forming apparatus A, a setting value of “fax” is undefined since the function cannot be used due to the configuration or the setting of the apparatus.

Regarding the image forming apparatus B, Sasaki has authority to use all authority information items. Regarding the image forming apparatus C, just like the image forming apparatus A, while Sasaki has authority to use “print/color” and “print/B/W”, a setting value of “fax” is undefined.

Regarding the image forming apparatus A, Tanaka has authority to use “print/B/W” but does not have authority to use “print/color”, and a setting value of “fax” is undefined.

Regarding the image forming apparatus B, Tanaka has authority to use “print/B/W” but does not have authority to use “print/color” and “fax”.

Regarding the image forming apparatus C, while Tanaka has authority to use “print/color” and “print/B/W”, a setting value of “fax” is undefined.

Regarding the image forming apparatus A, while Takahashi has authority to use “print/color” and “print/B/W”, a setting value of “fax” is undefined.

Takahashi is not registered in the image forming apparatus B.

Regarding the image forming apparatus C, while Takahashi has authority to use “print/B/W” but does not have authority to use “print/color”, and a setting value of “fax” is undefined.

The full powers user can use all functions in the apparatuses. However, regarding “fax” in the image forming apparatuses A and C, it is possible to use “fax” in those apparatuses if the setting or the configuration of those apparatuses can use facsimile.

A process performed in S87 in FIG. 7 is described below with reference to the flowchart in FIG. 11. It should be noted that the determination is performed based on the authority information in FIG. 10. In addition, “full powers user” is illustrated for reference and is not determined here.

The process described here starts when the authority management information generator 14 receives the authority management information generation request from the job controller 12, and the CPU 902 in the cooperative server P controls the process. The process is for one user, and the process is repeated for multiple time in case of generating the authority management information for multiple users.

In FIG. 11, in S301 and S307, the CPU 902 in the cooperative server P repeats steps S302 to S306 for all authority information items included in the authority information in FIG. 10. In this process, it is determined whether or not the authority information of the authority information item currently processed is “A” (available) for all cooperative apparatus included in the authority information in FIG. 10 sequentially in S302, S303, and S305. If there is one “A” at least, the process jumps from the loop S302 to S305, and the authority management information of the authority information item currently processed is set to “A” in S304.

By contrast, if the authority information is not “A” for all cooperative apparatuses A, B, and C (NO in S303), the loop S302 to S305 ends in S305, and the authority management information of the authority information item currently processed is set to “N” in S306.

After finishing steps S302 to S306 for all authority information items, the loop S301 to S307 ends, and the process in FIG. 11 ends.

A case taking Tanaka's authority information item “print/color” as an example is described below.

First, the CPU 902 determines whether or not Tanaka's authority for the authority information item “print/color” in S301 for the image forming apparatus A in S302 is set to “A” (available) in S303. Since Tanaka's authority for the authority information item “print/color” for the image forming apparatus A is “N” (not available) (NO in S303), it is determined whether or not for the image forming apparatus B subsequently in S303.

Here, Tanaka's authority is also “N” (not available) for the image forming apparatus B (NO in S303), it is determined whether or not for the image forming apparatus C again in S303. Since Tanaka's authority for the image forming apparatus C is set to “A” (available) (YES in S303), the authority management information is set to “A” in S304.

After performing steps described above, the CPU 902 determines that Tanaka has authority to use “print/color” in the cooperative system.

After that, the similar process is performed for all authority information items. After the CPU 902 finishes determining all authority information items, the process ends.

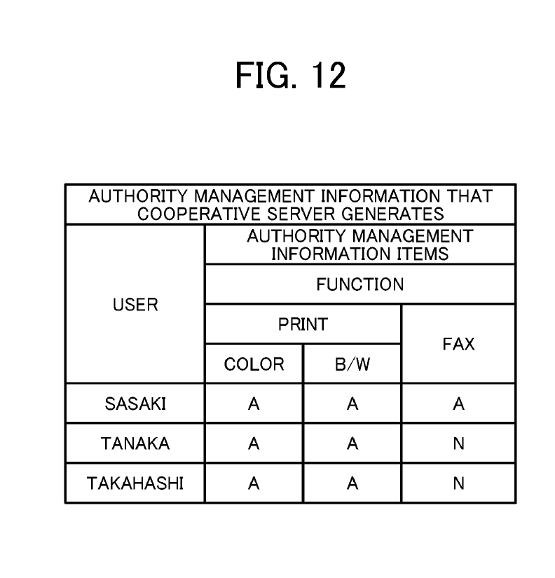

The process in which the CPU 902 performs the determination based on the authority information in FIG. 10 in accordance with the flowchart in FIG. 11 is described above. As a result, the authority management information in FIG. 12 is generated. In FIG. 12, functions that users have authority to use on any one of the apparatuses registered in the cooperative system (available functions) are indicated as “A”, and functions that users do not have authority to use on any apparatus registered in the cooperative system (not available functions) are indicated as “N”.

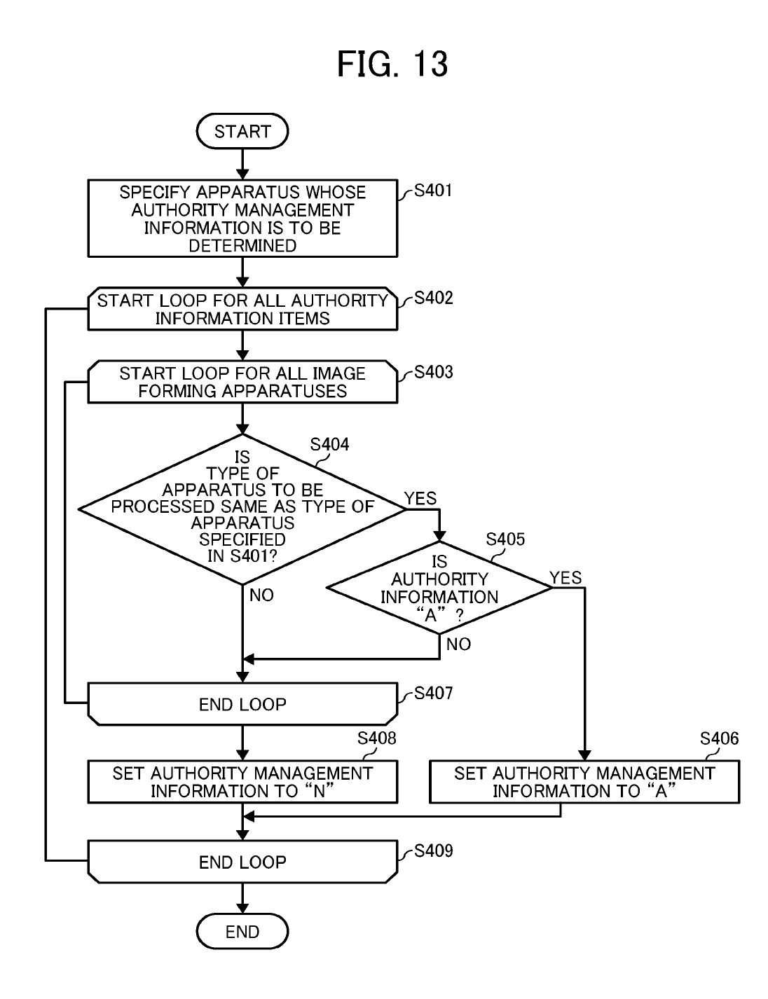

Another process performed in S87 in FIG. 7 is described below with reference to the flowchart in FIG. 13. In FIG. 13, the determination is performed for each type of the apparatuses. The description below is based on the authority information in FIG. 10. It should be noted that the determination is performed based on the authority information in FIG. 10. In addition, “full powers user” is illustrated for reference and is not determined here.

Just like the process in FIG. 11, the process described here starts when the authority management information generator 14 receives the authority management information generation request from the job controller 12, and the CPU 902 in the cooperative server P controls the process. The process is for one user, and the process is repeated for multiple time in case of generating the authority management information for multiple users.

In FIG. 13, first, the CPU 902 specifies an apparatus on which the authority management information is determined in S401. After the specification, steps S403 to S408 are repeated for all authority information items included in the authority information in FIG. 10 in S402 and S409.

In this case, all cooperative apparatus included in the authority information in FIG. 10 are processed sequentially, and in S404, it is determined whether or not the apparatus currently processed is the same type as the apparatus specified in S401.

If those types are the same (YES in S404), it is determined whether or not the authority information of the authority information item currently processed included in the authority information in FIG. 10 is “A” (available) in S405. If there is one “A” at least, the process jumps from the loop S403 to S407, and the authority management information of the authority information item currently processed is set to “A” in S406.

By contrast, if there is no apparatus that the determination in both S404 and S405 is yes, the loop S403 to S407 ends, and the authority management information of the authority information item currently processed is set to “N” in S408.

After finishing steps S403 to S407 for all authority information items, the loop S402 to S409 ends, and the process in FIG. 13 ends.

In conclusion, the process in FIG. 13 does not accumulate information on all apparatuses from which authority information can be acquired just like the process in FIG. 11 but accumulates information on apparatuses the same type as the specified apparatus for each type of apparatuses such as printer and MFP etc. and generates authority management information for each type.

Therefore, Tanaka has no authority to use “print/color” on the image forming apparatus A as the printer type, and there is no printer-type apparatus in the cooperative system. As a result, in the authority management information for printers, “print/color” is set to “N”. By contrast, regarding the MFP type, Tanaka has no authority to use “print/color” on the image forming apparatus B but has authority to use on the image forming apparatus C. Therefore, regarding the authority management information for MFPs, “print/color” is set to “A”.

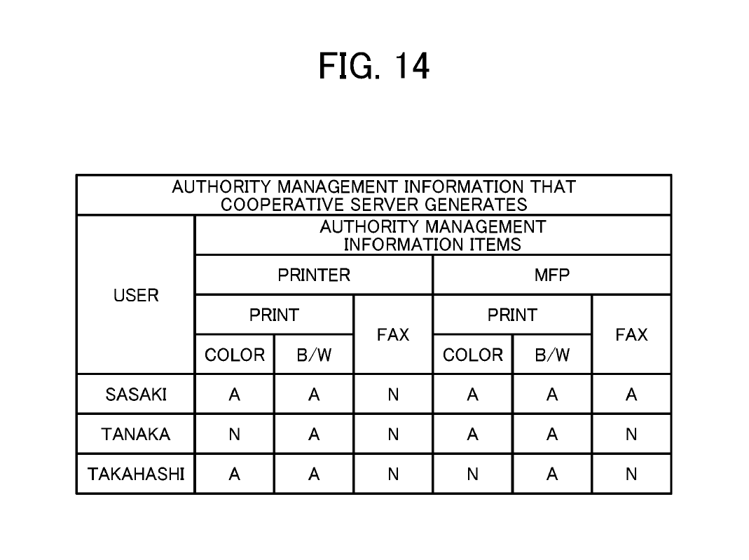

FIG. 14 is a diagram illustrating the authority management information generated by the determination in accordance with the process in FIG. 13.

In FIG. 14, the authority management information generated for the cooperative apparatus printer and the cooperative apparatus MFP for users Sasaki, Tanaka, Takahashi, and full powers user is illustrated. The legends for FIG. 14 are the same as in FIG. 12, and those descriptions are omitted.

The determination regarding S87 is described above.

Regarding the authority management information, it is possible to generate the authority management information for all apparatuses registered in the cooperative system. Otherwise, it is possible to limit to the specified apparatus.

By applying the authority management information described above to all apparatuses in the cooperative system, if a new function is added to an apparatus registered in the cooperative system and a new apparatus is added to the cooperative system, it is possible to control the cooperative operation reflecting existing authority settings without configuring user authority for the new function and the new apparatus individually. A case that authority settings on one apparatus conflict with authority settings on another apparatus can be processed similarly. In FIG. 11 and FIG. 13, if a user can use a function on at least any one of apparatuses within the range of referring to authority information, authority is adjusted so that the user can use the function on all apparatuses within the range of applying the authority management information. It should be noted that another adjusting algorithm can be used.

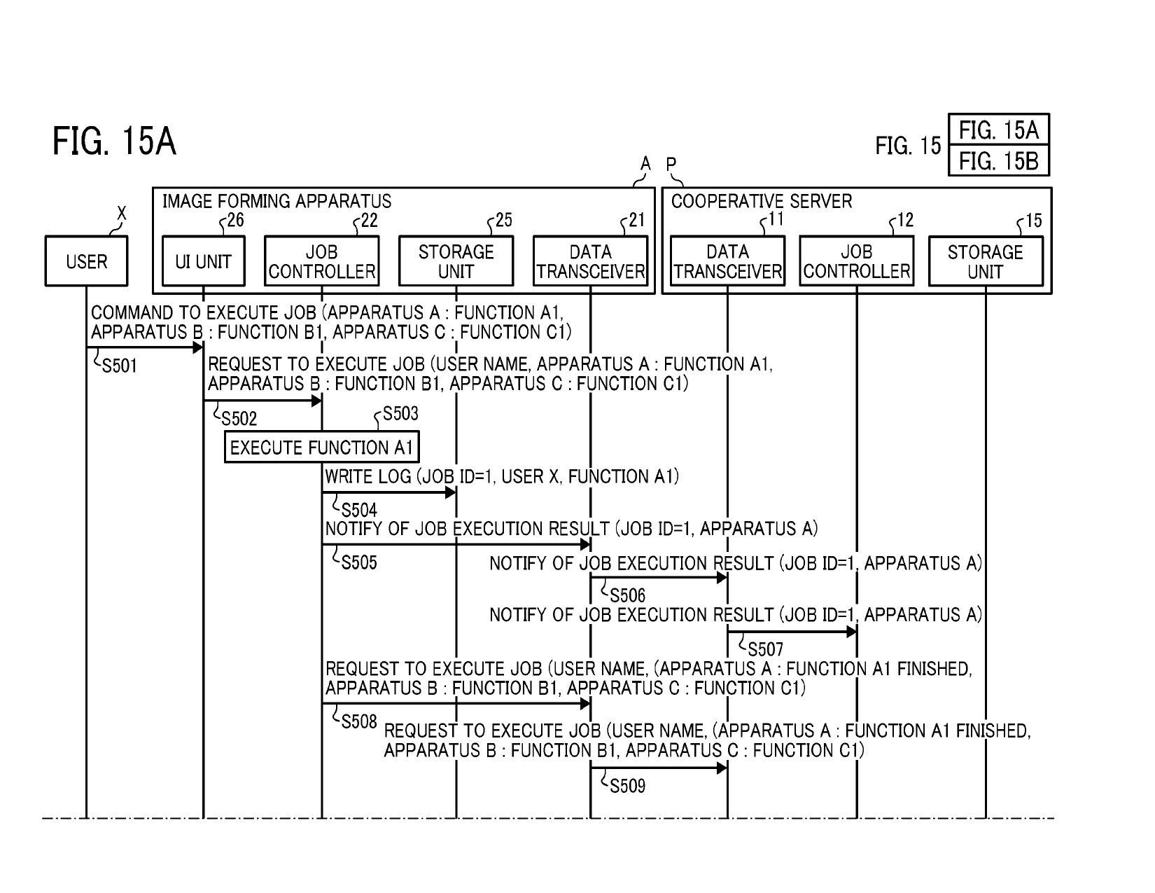

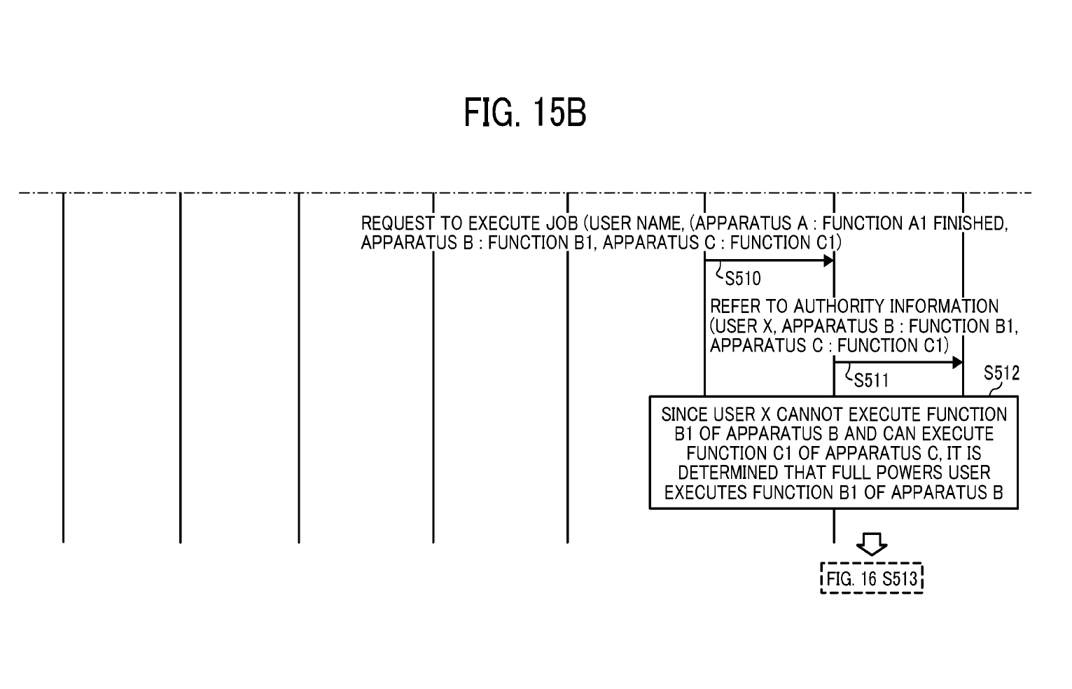

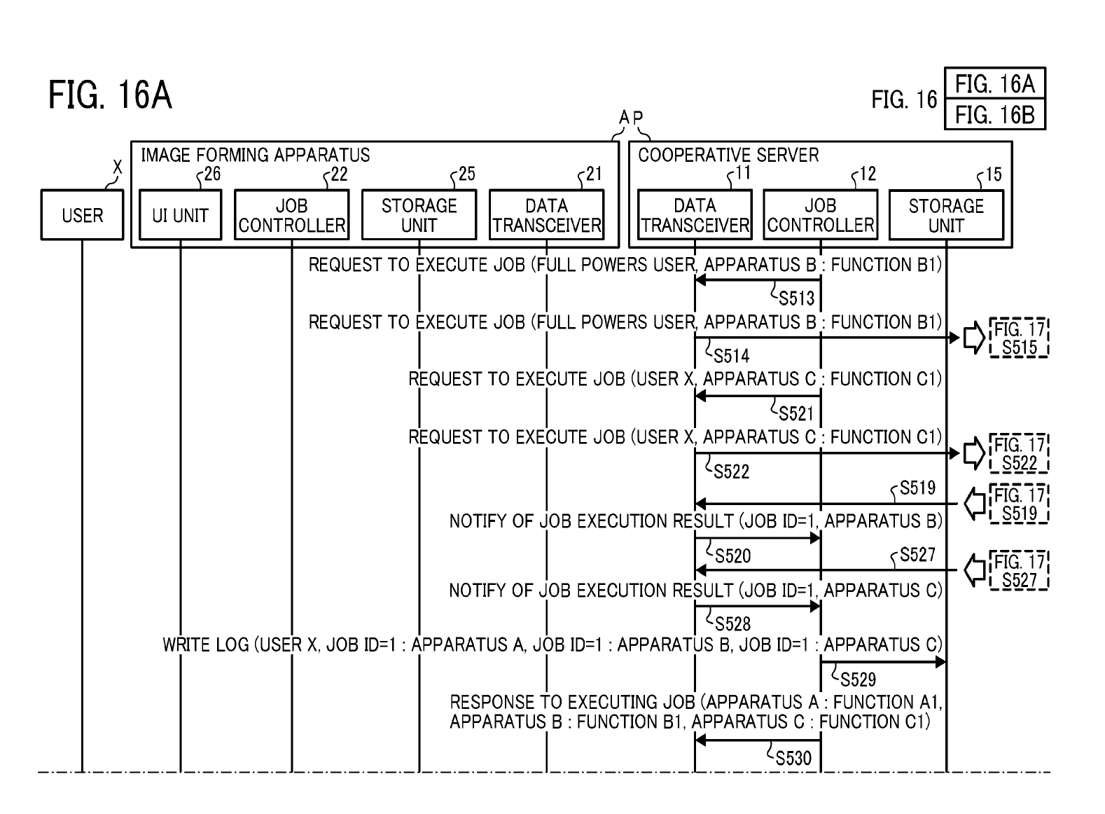

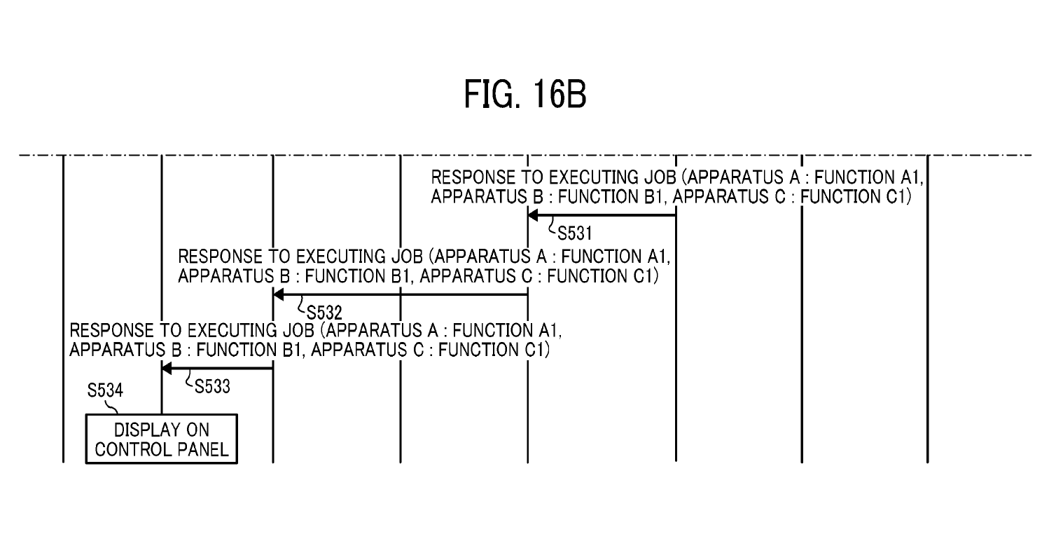

Next, with reference to FIGS. 15 and 16, a process in which executes a job using the cooperative system and a process in which registers a log of the executed job are described below.

In these processes, the CPU 902 controls the operation of the cooperative server P, the CPU 105 controls the operation of the image forming apparatus A, the CPU 205 controls the operation of the image forming apparatus B, and the CPU 305 controls the operation of the image forming apparatus C. In addition, the CPU 902 controls a process in which the cooperative server P requests multiple apparatuses preregistered in the cooperative system to execute a job. In these execution request processes, the CPU 902 functions as an execution request unit.

In this case, a function A1 of the image forming apparatus A, a function B1 of the image forming apparatus B, and a function C1 of the image forming apparatus C are selected on the UI unit 26 in the image forming apparatus A by user operation, and it is commanded to execute a job on the cooperative operation in S501. Here, the command is accepted based on the display in S64 in FIG. 5, and it is commanded to execute a selected function among the displayed functions.

After receiving the execution command in S501, in accordance with the command, the UI unit 26 passes the name of the job execution commander (user X) and a content of a job commanded to execute and requests to execute the job in S502.

After receiving the request, the job controller 22 executes the job of the function A1 that the image forming apparatus A executes itself in accordance with the execution request in S503.

After finishing executing the job, a log associating “job ID=1, user:user X, executed job:function A1” is written in the storage unit 25 in S504, and a job execution result is reported to the job controller 12 in the cooperative server P via the data transceiver 21 and 11 in S505, S506, and S507. In this case, the job ID and the name of the execution apparatus are reported.

The job ID is identification information on the executed function and can be an identifiable ID such as number, alphabet, or combination of number and alphabet etc. In addition, the order of the job ID can be arbitrary.

Next, the job controller 22 in the image forming apparatus A requests the job controller 12 in the cooperative server P to execute a job setting the user X as the execution requester and selecting the function A1 of the image forming apparatus A, the function B1 of the image forming apparatus B, and the function C1 of the image forming apparatus C via the data transceivers 21 and 11 as requested in S502. In this case, it is also reported that the function A1 of the image forming apparatus A has already been executed in S508, S509, and S510.

In S502, S508, and S509, in accordance with the user request, any one of the preregistered apparatus requests the cooperative server P to execute an operation on preregistered apparatuses, and the CPU 105 in the image forming apparatus A functions as a request unit.

The job execution request that the job controller 12 receives in S510 also corresponds to the user request. After receiving the job execution request, the job controller 12 refers to the user X's usage authority for the function B1 of the image forming apparatus B and the function C1 of the image forming apparatus C in the authority information in FIG. 10 in S511.

Here, after referring to the authority information, it is assumed to determine that the user X has no usage authority for the function B1 of the apparatus B. In this case, if it is requested the apparatus B to execute the requested job as the user X (using user X's account), it is determined that the execution is not allowed. Therefore, the job controller 12 determines that it is desired to request the apparatus B as the request destination to execute the function B1 using the full powers user's information. By contrast, after determining that the user X has usage authority for the function C1 of the apparatus C, it is determined that it is possible to request the apparatus C to execute the function C1 as the user X in S512.

While it is possible to issue all requests using the full powers user's information, since it is preferable to record user name in logs in each apparatus as much as possible, it is preferable to request as a user to execute a function executable with the user authority.

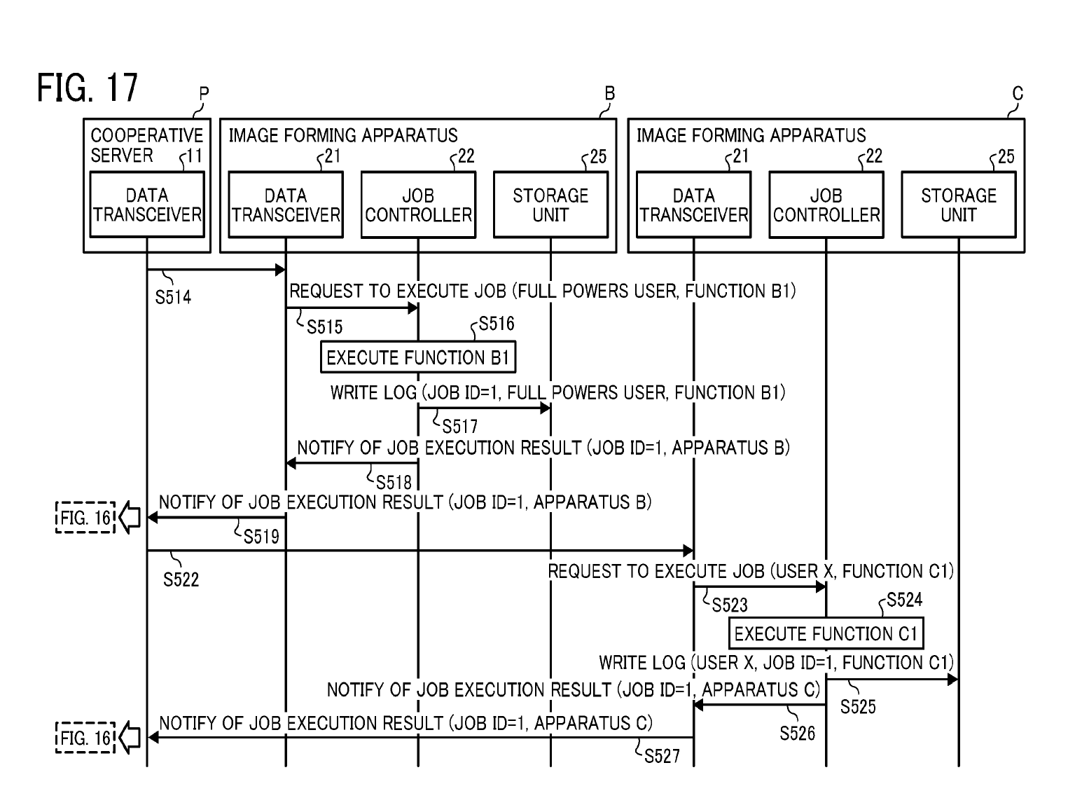

Next, in FIG. 16A, after the determination in S512, the job controller 12 requests the job controller 22 in the image forming apparatus B to execute the function B1 as the full powers user in S513 and S514 and S515 in FIG. 17). After receiving the request, as shown in FIG. 17, the job controller 22 executes a job for the function B1 in accordance with the request in S516.

In this embodiment, after receiving the job execution request in S510, the job controller 12 does not determine whether or not it is possible to execute the requested job with reference to the authority management information. That is, in this embodiment, a request to execute a cooperative operation by user operation is accepted only within options displayed as allowable operations in accordance with the authority management information (S62 in FIG. 5, etc.). Therefore, in the accepted execution request, operations that cannot each apparatus to request to execute based on the authority management information have already been eliminated.

As a result, in executing a cooperative operation, in case of not checking the content of the cooperative operation against the authority management information again, it is possible to control whether or not allowing to request each apparatus to execute the cooperative operation based on the authority management information. However, after accepting the execution request for the cooperative operation in S501, it is also possible to check the content of the cooperative operation against the authority management information again and determine whether to request each apparatus to execute the cooperative operation or not.

In FIGS. 15 to 17, after executing the job in S516 in FIG. 17, the job controller 22 writes a log associating “job ID=1, user:full powers user, executed job:function B1” in the storage unit 25 in S517 and notifies the job controller 12 in the cooperative server P about the job execution result (job ID, execution apparatus name, and executed function) in S518, S519, and S520.

The job controller 12 in the cooperative server P also requests the image forming apparatus C to execute a job, and the image forming apparatus C executes the job and records a log in S521 to S528 (detailed description is omitted). It should be noted that the job controller 12 requests the image forming apparatus C to execute the job as the user X.

In this case, all job IDs in the cooperative operation are set to “1” for all of image forming apparatuses A, B, and C. However, in executing a cooperative operation by multiple image forming apparatuses, it is unnecessary to set all job IDs to the same for all image forming apparatuses, and it is possible that each apparatus sets its own job ID arbitrary.

After job execution results are reported to the job controller 12 in the cooperative server P from all apparatuses that execute the cooperative operation in S507, S520, and S528, the job controller 12 writes a log associating the job execution requester, apparatuses that execute operations included in the job, and the job IDs as identification information in apparatuses that execute each operation in the storage unit 15 in S529. In FIG. 16A, the written log indicates “requester:user X, job ID=1:image forming apparatus A, job ID=1:image forming apparatus B, and job ID=1:image forming apparatus C”.

In S529, the cooperative server P registers the log, and the CPU 902 in the cooperative server P functions as the registration unit.

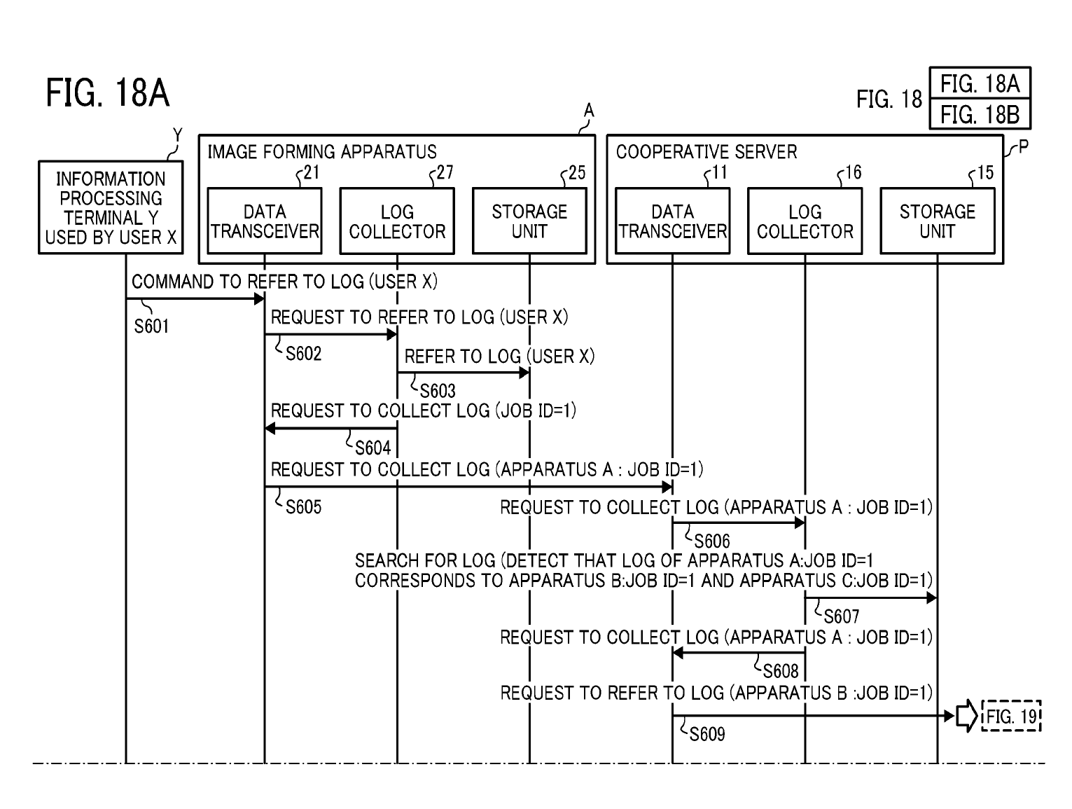

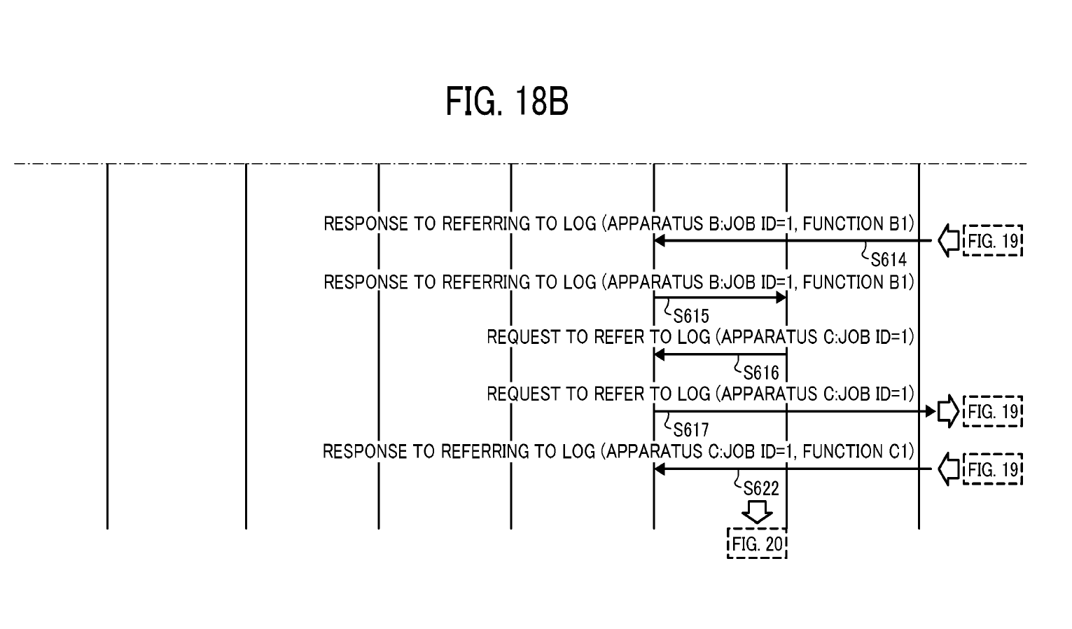

After writing the log, the log controller 12 notify the UI unit 26 in the image forming apparatus A that the job execution requested in S501 by user X operation ends via the data transceiver 11, the data transceiver 21 and the job controller 22 in the image forming apparatus A in S530 to S533 to display that on the control panel 102 in S534. It is unnecessary to store the information reported in steps S530 to S534 as a log in the image forming apparatus A. It is possible to acquire the information later by the process in FIGS. 18 to 20 if necessary.

The process in which, by using the cooperative system, the cooperative server requests each apparatus to execute a job, the destination apparatuses execute the job based on the authority management information, it is transferred to the cooperative server as the request origin that the execution ends along with the predetermined log, and the logs transferred by the apparatuses are registered is described above.

As described above, by using the system, even if the user X does not have authority for the function B1 of the image forming apparatus B, it is possible to request the image forming apparatus B to execute the job for the function B1 using the cooperative server.

Next, a process in which refers to the log of the job executed by the cooperative system and collects the log is described below with reference to FIGS. 18 to 20.

In the process, the log is collected, and the CPU 902 in the cooperative server P functions as a log collector.

In FIG. 18A, first, it is commanded to refer to the log of the specified job on the information processing device Y by user X operation in S601, and the image forming apparatus A is requested to refer to the log in S601 and S602. After receiving the request, the log collector in the image forming apparatus A searches for the log of the job executed by user X operation through the logs stored in the storage unit 25 in S603. In this case, it is assumed that the log of job ID=1 is identified.

In response, to acquire a log of the cooperative operation corresponding to the specified log if it exists, the log collector 27 requests the log collector 16 in the cooperative server P to collect the log via the data transceivers 21 and 11 in S604, S605, and S606. In this case, its own identification information and a log ID of the log identified in S603 are passed to the log collector 16. In FIG. 18A, the symbol “image forming apparatus A:job ID=1” indicates that.

After receiving the check request in S606, the log collector 16 searches for the log of the job for the cooperative operation including combination of identification information of the apparatus and the job ID included in the check request through logs written in the storage unit 15 (written in S529 in FIG. 16A). Subsequently, the other apparatus that executed the job together with the apparatus included in the check request and the job ID in the other apparatus are acquired in S607.

In this case, after searching though the log including information that the image forming apparatus A executed the job whose job ID is 1, it is assumed that information that indicates “image forming apparatus B and its jog ID=1” and “image forming apparatus C and its job ID=1” is acquired.

Next, based on the detection result in S607, the log collector 16 requests the apparatuses acquired by the search to transfer the log corresponding to the job ID acquired by the search.

In FIGS. 18 to 20, first, the log collector 27 in the image forming apparatus B is requested to check the log whose job ID is 1 via the data transceiver 21 in the image forming apparatus B in S608, S609, and S610. After receiving the request, the log collector 27 searches through the storage unit 25 for logs stored corresponding to job ID=1 in S611.

After that, log information that indicates “job ID=1, function B1” is reported to the log collector 16 in the cooperative server P in S612 to S615.

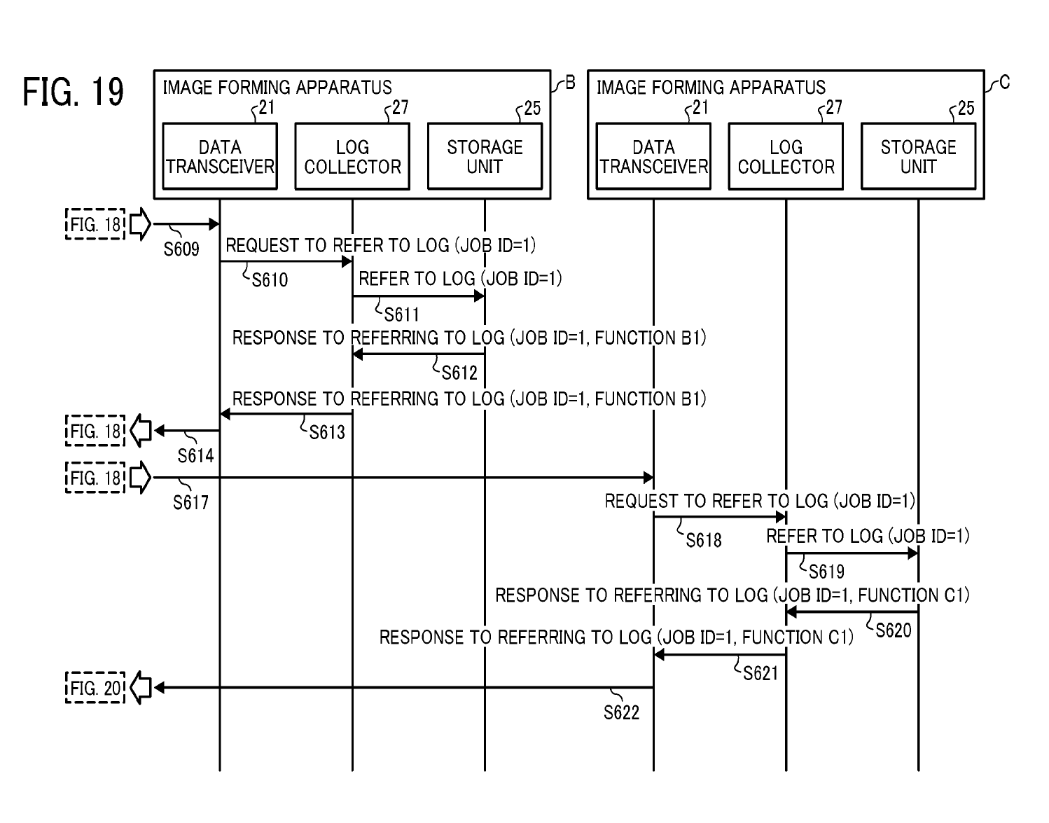

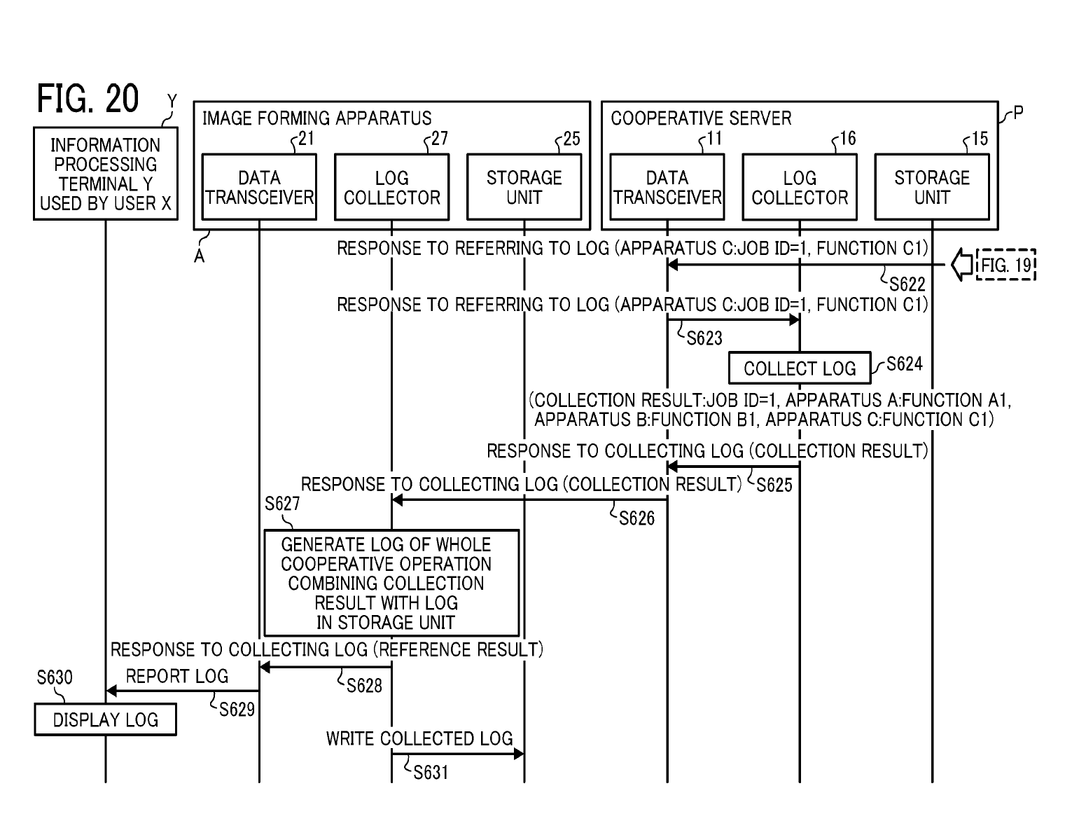

The log collector 16 in the cooperative server P also requests the image forming apparatus C as well, acquiring the log information that indicates “job ID=1, function C1” stored in the image forming apparatus C corresponding to job ID=1 in S616 to S623, also with reference to FIGS. 19 and 20.

After collecting logs based on the log check results transferred by each apparatus, the log collector 16 acquires the log collection results regarding the function B1 of the image forming apparatus B and the function C1 of the image forming apparatus C as the log of the cooperative operation that includes the operation on the image forming apparatus A whose job ID is 1 in S624.

The log collector 16 transfers the log information as the collection result to the log collector 27 in the image forming apparatus A as the request origin of collecting logs in S605 in FIG. 18A as the log collection result via the data transceivers 11 and 21 in S625 and S626.

After receiving the response, the log collector 27 combines the log of the operations on the image forming apparatus A acquired by the check in S603 in FIG. 18A with the logs of operations executed by other image forming apparatuses to generate the log of the whole cooperative operation in S627. Subsequently, the generated log is passed to the information processing device Y as the request origin to check logs in S601 via the data transceiver 21 in S628 and S629. After receiving the generated log, the information processing device Y displays the collected log referred by user operation via an operational display unit such as a display etc. (not shown in figures) in S630.

Otherwise, it is possible that the log collector stores the combined log in the storage unit 25 for the future reference in S631.

As described above, it is possible to check logs of operations cooperated with other apparatuses using the cooperative system by user operation. In addition, it is unnecessary to store the log of the cooperative operation in one apparatus, and it is possible that each image forming apparatus stores log of its own operations only and the cooperative server P stores information on the apparatus that executed the cooperative operations and identification information of the log in each apparatus only. Therefore, it is possible to reduce the storage sizes in each apparatus.

In S610, it is commanded to check the log using the information processing device Y by user X operation. However, it is not always necessary to use the information processing device Y, and it is possible to check the log by using any one of the image forming apparatuses preregistered in the cooperative serve. In that case, it is possible to request to check the log using the UI unit 26 in each image forming apparatus.

If the request origin is either the information processing device Y or any one of the apparatuses registered in the cooperative system, it is possible to check the log of the job using the cooperative system regardless of the apparatus that requested to execute the job.

In addition, it is possible that the cooperative server P collects logs in accordance with the log collection request only if the authenticated user requests to check the log. It is possible that either the image forming apparatus A that accepts the log check request by user operation or the cooperative serve P authenticates the user. In either case, it is possible to pass the user authentication information too when it is requested to check the log in S601 to authenticate the user.

As described above, unauthenticated users cannot check history of executed jobs.

In addition, it is possible that each user can check a log of his/her own operation only. In this case, if a user is not specified in requesting to collect logs, it is possible to assume that an authenticated user is specified automatically, and it is possible to regard logs corresponding to the user as target of search or collection.

As a result, since each user cannot refer to other user's log, it is possible to enhance security.

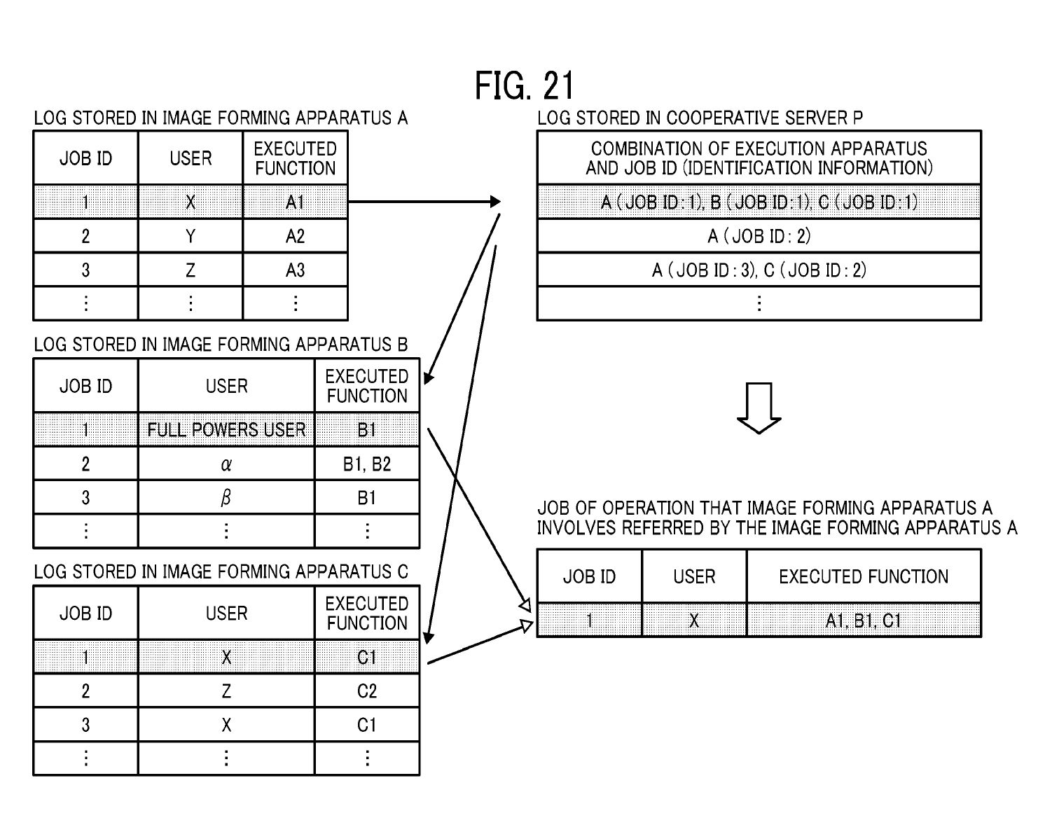

FIG. 21 is a diagram illustrating a process of collecting a log executed by using the cooperative system in this embodiment. A process in which collects a log of the cooperative operation related to a log of “job ID=1” stored in the image forming apparatus A is described below with reference to FIG. 21. In FIG. 18A, it is assumed that user X's log is checked by user operation in S601 and the log collector 27 specifies that the corresponding log is “job ID=1” log. However, it is possible to check the log by specifying the job ID by user operation from the start.

In either case, the image forming apparatus A inquires of the cooperative server P about a log stored in the image forming apparatus A corresponding to “job ID=1”. In response, the cooperative server P searches through information on combination apparatuses that execute operations in the cooperative operation with the log ID of the operation in the apparatus stored in the cooperative server P for a log including the combination of the image forming apparatus A and “job ID=1”.

In FIG. 21, after the search, information in the top line is hit. In FIG. 21, information in one line corresponds to a log of a job for one cooperative operation.

Based on the information above, the cooperative server P requests the image forming apparatuses B and C included in the information other than the image forming apparatus A to transfer the job log corresponding to “job ID=1”. In response, by combining the logs transferred by the image forming apparatuses B and C with the log stored in the image forming apparatus A, it is possible to generate the log for the whole cooperative operation including executed functions A1, B1, and C1 related to the cooperative operation.

In FIGS. 18 to 20, the image forming apparatus A processes the combination described above. However, it is possible that another apparatus such as the cooperative server P acquires the log from the image forming apparatus A too and processes the combination including the part of the image forming apparatus A.

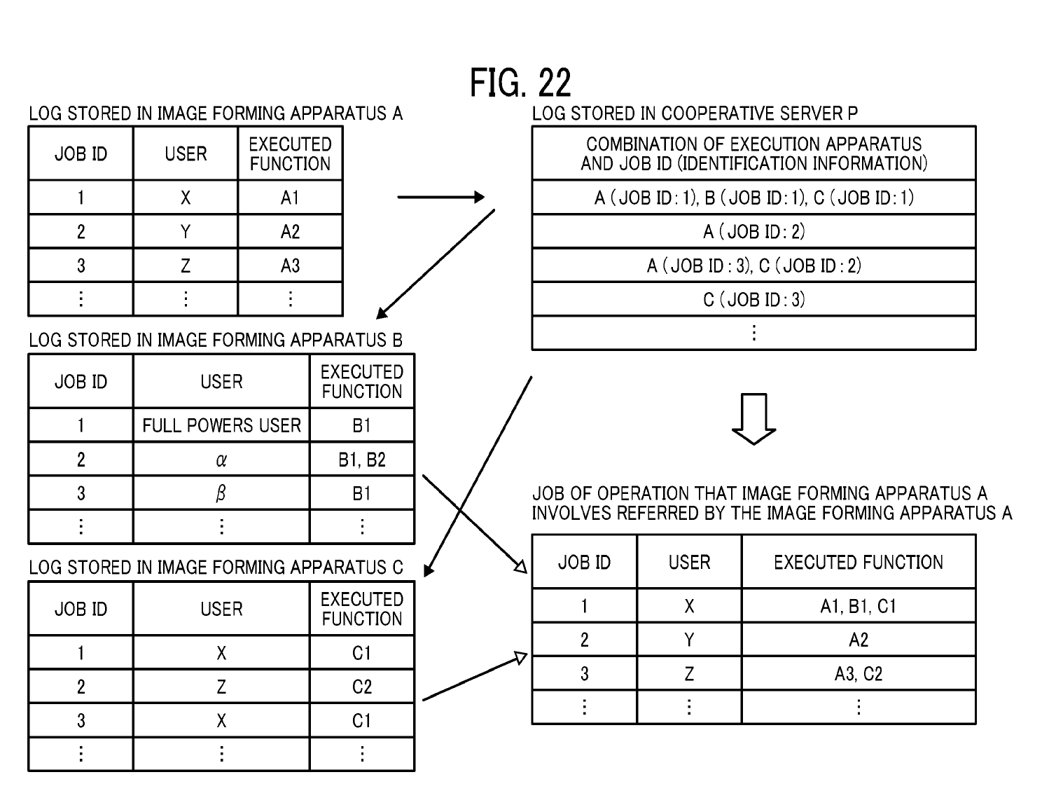

In FIG. 22, the log collection shown in FIG. 21 is performed on all logs stored in the image forming apparatus A. In this case, logs are collected from each apparatus just like in FIG. 21 for information other than information involved with the image forming apparatus A (e.g., information in line 4) and combined.

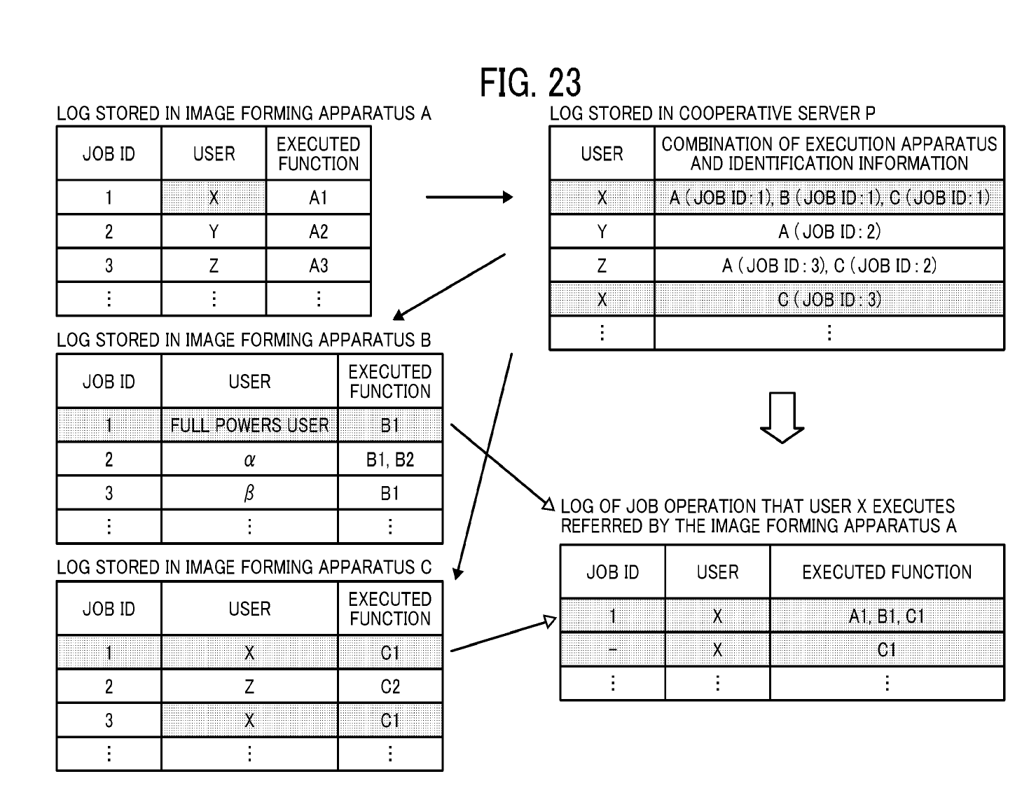

FIG. 23 is a diagram illustrating another process of collecting a log executed by using the cooperative system in this embodiment.

In FIG. 23, different from FIGS. 18 to 20, in case of specifying user X and requesting to check user X's log, the job ID corresponding to the user X is not specified on the image forming apparatus A, and the cooperative server P is requested to collect logs of a job requested to execute by user X operation.

To cope with the request described above, it is desired that the cooperative sever P stores identification information on user who executed the job in each log too. In addition, if it is requested to collect logs of the job requested to executed by user X operation, the cooperative server P refers to all log registered in accordance with the user X and requests the image forming apparatuses included in the log to transfer logs of job ID included in the log to acquire the information. In this case, it is possible to include the image forming apparatus that requests the collection.

By combining these logs, it is possible to generate the log regarding all cooperative operations requested to execute by user X operation. As shown in line 2, it is also possible that a log of a job that the image forming apparatus A as the collection requester is not involved is included.

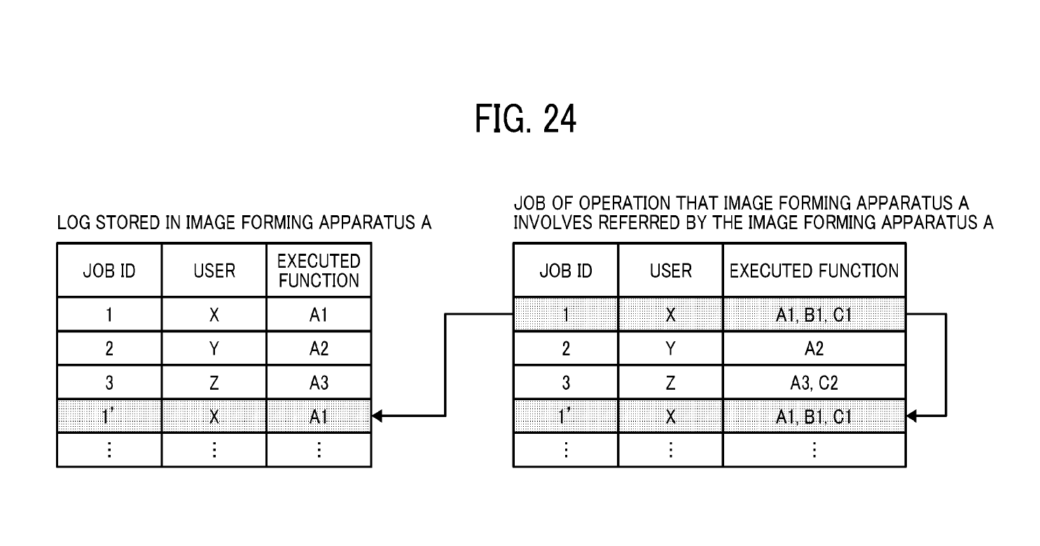

A process in which collects logs in case of executing a job using a log stored in the image forming apparatus A is described below with reference to FIG. 24.

The log collected in accordance with the log check request can be stored in the image forming apparatus as the log check request origin in S631.

In addition, in case of executing a job the same as a previous one, it is possible to specify any one of the stored logs and request to execute an operation the same as the operation in the specified log again.

In FIG. 24, for example, it is possible to command to execute the job whose job ID is 1 stored in the image forming apparatus A again by user operation. In this case, the image forming apparatus A refers to the log of the cooperative operations and requests the cooperative server P to execute the cooperative operation that includes the functions A1, B1, and C1.

It is considered that the log of the cooperative operation executed in response to the request is almost the same as the log of the job whose job ID is 1 except for execution date and time etc. Therefore, the image forming apparatus A copies the log of the job used for commanding the execution again and uses it as the log of the job executed again.

For example, as shown in FIG. 24, regarding the log whose job ID is 1′ executed with reference to the history of job ID=1, it is possible to create the log without collecting logs by storing the referred history as the history of job ID=1′.

As described above, it is possible to save trouble of collecting logs.

The collection of logs is described above. Regarding the jobs executed by using the cooperative system as described above, each apparatus stores the log (requester name and executed function) of the job executed on the apparatus itself, and the cooperative server only stores information on requester, execution apparatus, its job ID, and cooperative apparatus and its job ID associated with that. As described above, it is possible to save burden on the storage unit in the cooperative server.

In addition, the logs registered in the cooperative server P are stored for each of user request associated with the user who commanded to execute the job. Therefore, if it is requested to refer to logs specifying a user, it is possible to return all log information of the user for each log information operated in accordance with the execution request.

In addition, it is possible to refer to history of other apparatuses by any apparatus connected to the cooperative system. For example, regarding a job requested to execute by the image forming apparatus A, it is possible that the image forming apparatus B collects a log of the job and executes the same job again.

In the embodiment described above, the specific configuration of the apparatuses, the specific sequence of the processes, the system configuration, etc., are not limited to that described above.

In the above description, it is assumed that the image forming apparatuses are registered in the cooperative system. However, that is not limited to the image forming apparatuses, and it is possible to register any information processing apparatus that execute a job for functions other than the image formation. In the information processing apparatuses, it is possible that the image processing apparatuses that execute an image processing of image data are included, and it is possible to include apparatuses that include functions not related to images at all.

In addition, it is possible that any apparatus registered in the cooperative system including the image forming apparatuses A, B, and C includes the function of the cooperative server. It is also possible that the functions of the cooperative server are distributed to multiple apparatuses. In this case, the multiple apparatuses cooperate with each other to function as the information processing system.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these. The hardware platform includes any desired kind of hardware resources including, for example, a central processing unit (CPU), a random access memory (RAM), and a hard disk drive (HDD). It is also possible to download the program from an external apparatus that includes a storage medium storing the program or stores the program in a storage unit and install the program in the computer to execute the program. The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. An information processing system, comprising:
an execution request unit to request one or more multiple preregistered apparatuses to execute an operation in accordance with user instruction;
an authority information acquisition unit to acquire authority information that indicates user authority on the preregistered apparatus from at least one of the preregistered apparatuses;
an authority management information generator to generate authority management information that indicates the user authority applied to the preregistered apparatuses based on the authority information that the authority information acquisition unit acquires; and
a controller to control whether or not to allow the execution request unit to request to execute the operation based on the authority management information.

2. The information processing system according to claim 1, further comprising an acquisition unit to acquire, for each one of the preregistered apparatuses, information on a full powers user authorized to execute all operations that the execution request unit can request to execute from a predetermined storage unit,
wherein the controller instructs the execution request unit to request a destination apparatus to execute the operation in accordance with the user instruction if the destination apparatus does not allow the user to execute the operation in accordance with the user instruction at least in cases in which it is determined to allow the request to execute the operation in accordance with the user instruction based on the authority management information.

3. The information processing system according to claim 1, wherein the authority management information generator generates the authority management information that indicates the user authority applied to the preregistered apparatuses based on the authority information that the authority information acquisition unit acquires from at least one apparatus of the same type as the preregistered apparatuses.

4. The information processing system according to claim 1, wherein the authority information acquisition unit acquires the authority information that indicates the user authority on the preregistered apparatus from all of the preregistered apparatuses, and the authority management information generator generates the authority management information based on all of the authority information that the authority information acquisition unit acquires.

5. The information processing system according to claim 1, wherein the authority management information generator generates the authority management information so that the authority management information also allows a request to execute the operation that the user is allowed in any of the authority information acquired by the authority information acquisition unit.

6. The information processing system according to claim 1, further comprising a registration unit to associate and register the instruction, an apparatus that executes the operation, and identification information on the operation reported by the apparatus that executes the operation if the execution request unit requests one or more apparatuses among the preregistered apparatuses to execute the operation in accordance with user instruction.

7. The information processing system according to claim 6, further comprising a log collector to acquire, in response to a check request specifying an apparatus among the preregistered apparatuses and identification information on an operation executed by the specified apparatus, log information on the operation that is registered in association with the specified apparatus and the identification information of the check request.

8. The information processing system according to claim 7, wherein the log collector acquires the log information assuming that an apparatus origin of the check request is identified if the check request is received from any one of the preregistered apparatuses.

9. The information processing system according to claim 6, wherein the registration unit registers the apparatus that executes the operation and the identification information of the operation associated with the identification information of a user who issues the instruction for each user instruction,
the information processing system further comprising a log collector to acquire, in response to a check request specifying a user, log information of the operation that is registered in association with the instruction each issued by the specified user from the operation registered in association with the instruction each issued by the specified user, and transfers the acquired log information to an origin of the check request.

10. The information processing system according to claim 9, wherein the log collector collects the log information if the user specified in the check request is authenticated by the origin of the check request.

11. The information processing system according to claim 7,
wherein, when a user instruction for executing an operation that is the same operation indicated by the stored log information is received, the request unit requests the first information processing apparatus to instruct the one or more preregistered apparatuses to execute the operation using the stored log information, and the log management unit provides the stored log information as log information in response to a check request.

12. A method of processing information, comprising the steps of:
requesting one or more multiple preregistered apparatuses to execute an operation in accordance with user instruction;
acquiring authority information that indicates user authority on the preregistered apparatus from at least one of the preregistered apparatuses;
generating authority management information that indicates the user authority applied to the preregistered apparatuses based on the authority information that the authority information acquisition unit acquires; and
controlling whether or not to allow the execution request unit to request to execute the operation based on the authority management information.

13. A non-transitory, computer-readable recording medium storing a program that, when executed by a processor, causes the processor to implement a method of processing information, comprising the steps of:
requesting one or more multiple preregistered apparatuses to execute an operation in accordance with user instruction;
acquiring authority information that indicates user authority on the preregistered apparatus from at least one of the preregistered apparatuses;
generating authority management information that indicates the user authority applied to the preregistered apparatuses based on the authority information that the authority information acquisition unit acquires; and
controlling whether or not to allow the execution request unit to request to execute the operation based on the authority management information.
